(19) United States
(12) Patent Application Publication
(10) Pub. No.: US 2025/0315849 A1
(43) Pub. Date: Oct. 9, 2025

(54) DYNAMIC BAGEL PRODUCTION PLANS

(71) Applicant: JBR Franchise Co, Orlando, FL (US)

(72) Inventors: Justin Michael Wetherill, Windermere, FL (US); Jeffrey Perera, Windermere, FL (US); Danielle Leisa Perera, Windermere, FL (US); Aaron Joseph LeClair, Orlando, FL (US); David James Reiff, Orlando, FL (US); Bryan Andrew Burr, Orlando, FL (US); Joshua Alcantara, Orlando, FL (US)

(21) Appl. No.: 18/886,605

(22) Filed: Sep. 16, 2024

Related U.S. Application Data
(60) Provisional application No. 63/574,699, filed on Apr. 4, 2024.

(51) Int. Cl. G06Q 30/0202; G06Q 10/087

(52) U.S. Cl. CPC G06Q 30/0202; G06Q 10/087

(57) ABSTRACT

This disclosure outlines the implementation details of a dynamic production system designed to prepare dough and bake oven-fresh, hot, high-quality bagels in a variety of flavors upon placing an order. The dynamic production system utilizes various technical features, including just-in-time bagel production and machine learning models, to proactively generate both bagel preparation plans and bagel production plans. These plans precisely incorporate the specific timing requirements associated with bagel production. Additionally, the dynamic production system reactively updates the bagel production plan continuously throughout the day to seamlessly absorb real-time changes, such as fluctuations in inventory levels, additional orders, and cooking equipment capacity. By doing so, the dynamic production system ensures that fresh, high-quality bagels in a variety of flavors are consistently available for order at any given time, while maximizing bagel production efficiency and minimizing both product and energy waste.

### CROSS-REFERENCE TO RELATED APPLICATIONS

This application claims benefit and priority to Provisional Application No. 63/574,699, filed on Apr. 4, 2024, the entirety of which is incorporated herein by reference.

### BACKGROUND

Advancements in hardware and software have revolutionized food production processes, yet bagel production remains a unique challenge. Unlike many other food items, bagels follow a multi-day process with precise timing requirements. Additionally, bagels have an extremely short window of optimal freshness before their quality and taste deteriorate.

As a result of these and other challenges, current bagel production systems struggle to consistently provide fresh, hot bagels throughout the day. Instead, they often rely on reheating partially-baked or frozen batches. Furthermore, current bagel production systems not only fail to consistently provide fresh bagels, but they are also designed in ways that hinder the implementation of various technical features and improvements that could enhance bagel production and quality. These and other problems exist with current bagel production systems.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of the dynamic production system generating and updating a bagel production plan to provide fresh, hot bagels throughout a target day.

FIG. 2 illustrates an example computing environment where the dynamic production system is implemented.

FIGS. 3A-3D illustrate example block diagrams of the dynamic production system updating a bagel production plan throughout a given day based on various factors.

FIGS. 4A-4B illustrate example tables associated with a bagel production plan and an updated bagel production plan to facilitate optimized tray scheduling.

FIG. 5 illustrates an example sequence diagram of the dynamic production system updating a bagel production plan throughout a given day based on various factors.

FIG. 6 illustrates an example block diagram of how interleaving hot dozen orders into the dynamic production system affects a bagel production plan.

FIG. 7 illustrates an example sequence diagram of interleaving hot dozen orders into the dynamic production system.

FIGS. 8A-8H illustrate graphical user interface flows associated with the dynamic production system.

FIGS. 9A-9B illustrate graphical user interface flows associated with adjusting a bagel production plan.

FIGS. 10A-10C illustrate graphical user interface flows associated with a user order experience.

FIG. 11 illustrates an example series of acts of a computer-implemented method for managing just-in-time bagel production to ensure fresh, hot bagels.

FIG. 12 illustrates example components included within a computer system used to implement the dynamic production system.

### DETAILED DESCRIPTION

This disclosure outlines the implementation details of a dynamic production system designed to deliver oven-fresh, hot, high-quality bagels in a variety of flavors upon placing an order. The dynamic production system utilizes various technical features, including just-in-time bagel production and machine learning models, to proactively generate both bagel preparation plans and bagel production plans. These plans precisely incorporate the specific timing requirements associated with bagel production. Additionally, the dynamic production system reactively updates the bagel production plan continuously throughout the day to seamlessly absorb real-time changes, such as fluctuations in inventory levels, additional orders, and cooking equipment capacity. By doing so, the dynamic production system ensures that fresh, high-quality bagels in a variety of flavors are consistently available for order at any given time, while maximizing bagel production efficiency and minimizing both product and energy waste.

Notably, while this document describes the dynamic production system in the context of bagel production, the concepts and implementations described in connection with the dynamic production system may be expanded to cover other products that have diminishing quality lifespans. Accordingly, while the terms “bagel” and “bagel production” are used, in some instances, these terms can be substituted with “item” and “item production.” Similar substitutions may be made in other implementations as appropriate.

Implementations of the present disclosure provide benefits and solve problems in the art by using systems, computer-readable media, and computer-implemented methods that implement a dynamic production system (e.g., a dynamic bagel production system or a dynamic production item system) to deliver oven-fresh, hot, high-quality bagels across a variety of flavors at the time of order. In various implementations, the dynamic production system uses up-to-the-moment bagel production plans to determine when to cook which bagel product given current demands, future demands, and cooking equipment capacities. In various implementations, the dynamic production system uses various technical components and elements, as described in this document, to ensure accurate and up-to-date bagel production plans.

To illustrate, in one or more implementations, the dynamic production system receives daily bagel inventory predictions for future dates, including a target date, from an inventory prediction machine learning model, which generates the daily bagel inventory predictions using historical inventory data. In various instances, the daily bagel inventory predictions include bagel types and corresponding quantities for the target date. Based on the daily bagel inventory predictions, the dynamic production system generates a bagel preparation plan and an initial bagel production plan for the target date, where the initial bagel production plan includes sets of bagels to be cooked at designated times throughout the target date. Additionally, the dynamic production system generates updated bagel production plans throughout the target date based on receiving real-time bagel inventory data. Using the updated bagel production plans, the bagels can be prepared and cooked at the designated times.

As another illustration, in some instances, the dynamic production system provides historical sales data to an inventory prediction machine learning model to generate bagel sales predictions for one or more future dates, including a target date. In addition, the dynamic production system uses the bagel sales predictions with a baking au-dough-mation system (BAS) (a.k.a., a baking automation system) that generates a bagel preparation plan for the target date, which includes a quantity of plain or standard bagel dough and a bagel production plan. In various instances, the bagel production plan for the target date includes a first set of bagels of one or more bagel types to begin processing at a first time on the target date for fresh, hot orders or distribution and a second set of bagels of different bagel types to begin processing at a second time on the target date for fresh, hot orders or distribution. In some instances, the bagel production plan is generated based on the bagel sales predictions, a consumption function, future orders for bagels on the target date, and oven bagel capacity.

As another illustration, the dynamic production system provides previous inventory data to an inventory prediction machine learning model, which generates item inventory predictions for future dates (including a target date) where the item inventory predictions include item types and corresponding quantities for the target date. In addition, the dynamic production system generates an item preparation plan for the target date based on the item inventory predictions. In various instances, the item preparation plan includes a quantity of product to prepare before the target date. The dynamic production system also generates an item production plan for the target date. In some instances, the item production plan includes a first set of items of one or more item types to begin processing at a first time (or a first time interval) on the target date for distribution at the optimal quality as well as a second set of items of different item types to begin processing at a second time (or a second time interval) on the target date for distribution at the optimal quality. In some instances, the item production plan is generated based on the item inventory predictions, an item request model, future requests for items on the target date, and item production capacity. Additionally, the dynamic production system provides the item production plan for producing items according to the item production plan in one or more production machines.

Additionally, the dynamic production system provides one or more interactive interfaces that allow for processing and progressing through various operations of the bagel production process without navigating away. For example, the dynamic production system provides a production user interface that guides the user through the various steps to prepare and cook bagels and automatically updates (including both frontend and backend updates) based on user input. Other bagel production systems do not provide these types of seamless and interactive user interfaces that reduce menu complexity and lead to efficiency gains throughout the bagel production process.

As described in this disclosure, the dynamic production system delivers several significant technical benefits in terms of improved efficiency, accuracy, and flexibility compared to existing bagel production systems. Moreover, the dynamic production system provides several practical applications that address problems related to providing oven-fresh, hot, high-quality bagels (e.g., just-in-time bagel delivery) across a variety of flavors at the time of order.

As mentioned earlier, existing bagel production systems fail to provide fresh, hot bagels throughout the day due to their inefficiency and inflexibility. Indeed, many existing bagel production systems rely on reheating partially-baked or frozen batches which are left to sit on shelves for extended periods before being toasted at the point of sale, creating a false impression of freshness. However, toasted bagels are an inadequate substitute for oven-fresh, hot, high-quality bagels. The rigidity of existing bagel production systems along with the complexity of bagel production prevent existing bagel production systems from preparing, baking, and delivering fresh, hot bagels on demand.

As an illustrative example, when an existing bagel production system receives an order for a future time, many existing systems fulfill the order before the scheduled time with existing bagel stock. If toasted, the existing systems process the order closer to the pickup time but still with existing or set-aside inventory cooked earlier in the day. In these cases, even with sufficient lead-up time, these existing systems are too rigid and inefficient to cook fresh bagels for future orders. Existing systems commonly bake all their batches early in the day and then turn their ovens off, making it infeasible to cook fresh bagels for orders taken later in the day.

In contrast to existing bagel production systems, the dynamic production system provides improved efficiency, accuracy, and flexibility throughout the dynamic production process by leveraging technical components and elements. For example, the dynamic production system utilizes an inventory prediction machine learning model to generate daily bagel (or item) inventory predictions. These inventory predictions provide initial estimates of which bagel types to make available and at what quantities for one or more days in the future based on predicted demand. For example, in some instances, the dynamic production system utilizes the inventory prediction model once a week to generate multiple daily bagel inventory predictions for an upcoming week or month. By using inventory predictions from an inventory prediction model, the dynamic production system can generate more efficient and accurate bagel preparation plans and bagel production plans.

By using the dynamic production system to generate and continuously update bagel production plans throughout the day, the dynamic production system improves the flexibility and efficiency of bagel production, which is often a complex process. For example, the dynamic production system flexibly adapts to real-time changes (e.g., inventory changes, incoming orders, time of day, cooking equipment capacity, raw stock qualities, staff availability, and device management). Based on incoming data, the dynamic production system frequently updates a bagel production plan to efficiently and seamlessly absorb these changes. This way, the dynamic production system maintains an optimized bagel production plan that maximizes bagel production efficiency while also minimizing both product and energy waste.

As an example, if an order for a hot dozen arrives, the dynamic production system determines how to reallocate existing planned bagel production to reserve a designated rack in an oven for the hot dozen order to be completed and packed piping hot at the guaranteed time while ensuring that the particular bagel timing requirements are kept for all bagel production. More than just reallocating existing planned bagel production, the dynamic production system updates the bagel production plan to ensure that fresh bagels of specific types (e.g., flavors) are available at the current times so that stock does not run out while also ensuring that bagels are not produced too far in advance that they begin to deteriorate in quality (e.g., they are served within a freshness time threshold). The dynamic production system updates bagel production plans to flexibly adapt to changes while ensuring that bagel production is as efficient as possible.

As illustrated in the preceding discussion, this document uses a variety of terms to describe the features and advantages of one or more described implementations. For instance, this document describes an inventory prediction machine learning model.

For example, the term “machine learning model” refers to a computer model or computer representation that can be trained (e.g., optimized) based on inputs to approximate unknown functions. For instance, a machine learning model can include, but is not limited to, a neural network (e.g., a convolutional neural network (CNN) or deep learning model), a decision tree (e.g., a gradient-boosted decision tree), a linear regression model, a logistic regression model, or a combination of these models.

As another example, the term “neural network” refers to a machine learning model comprising interconnected artificial neurons that communicate and learn to approximate complex functions, generating outputs based on multiple inputs provided to the model. For instance, a neural network includes an algorithm (or set of algorithms) that employs deep learning techniques and uses training data to adjust the parameters of the network and model high-level abstractions in data. Various types of neural networks exist, such as convolutional neural networks (CNNs), residual learning neural networks, recurrent neural networks (RNNs), generative neural networks, generative adversarial neural networks (GANs), and single-shot detection (SSD) networks.

Additionally, the term “oven-fresh distribution” refers to providing, serving, or delivering one or more bagels (or items) to a user, such as a customer, within a “freshness time threshold” of the one or more bagels completing the cooking process. In this document, the term “freshness time threshold” refers to an amount of time, time window, or time interval during which a bagel is at optimal quality and freshness. Often, a bagel served within the freshness time threshold is piping hot. As mentioned below, there may be multiple freshness time thresholds corresponding to different time lengths and acceptable quality levels. In some instances, a freshness time threshold refers to a time window during which an item is at optimal quality and freshness before the quality begins to diminish.

Additional terms are defined throughout the disclosure in connection with various examples and contexts.

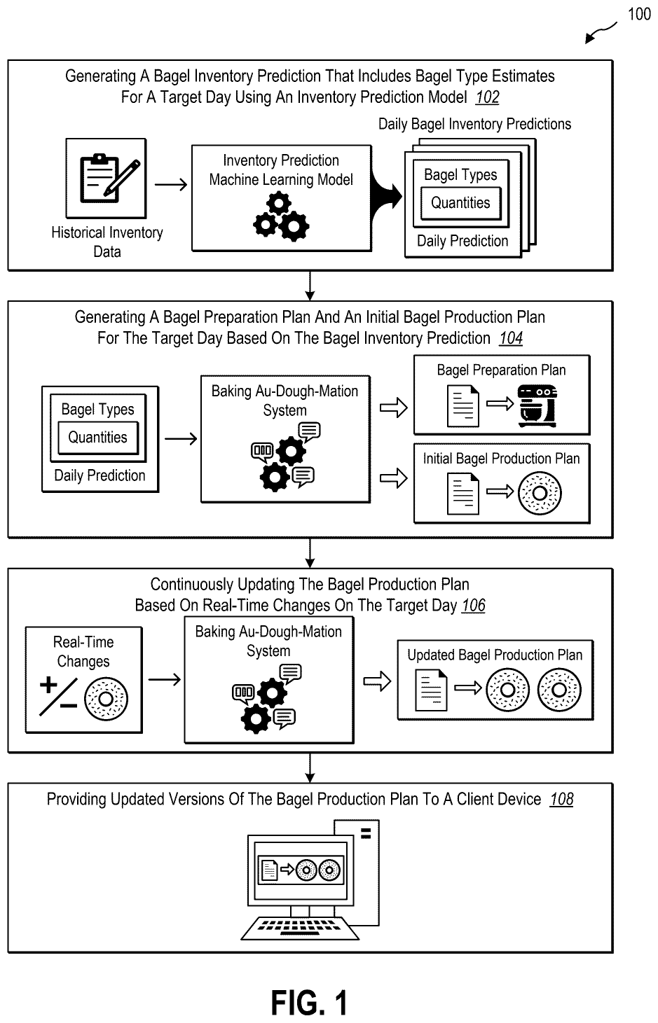

Implementation examples and details of the dynamic production system are discussed in connection with the accompanying figures, which are described next. For example, FIG. 1 illustrates an overview of the dynamic production system generating and dynamically updating a bagel production plan to provide fresh, hot bagels throughout a target day according to some implementations. While FIG. 1 provides a high-level overview of the invention, additional details are provided in subsequent figures.

FIG. 1 illustrates a series of acts 100 performed by or following directions from the dynamic production system. As shown, the series of acts 100 briefly illustrates an example of how the dynamic production system uses various technical components and elements to generate, dynamically update, and implement a bagel production plan to provide high-quality bagels throughout the day in anticipation of demand and in response to real-time changes as they occur.

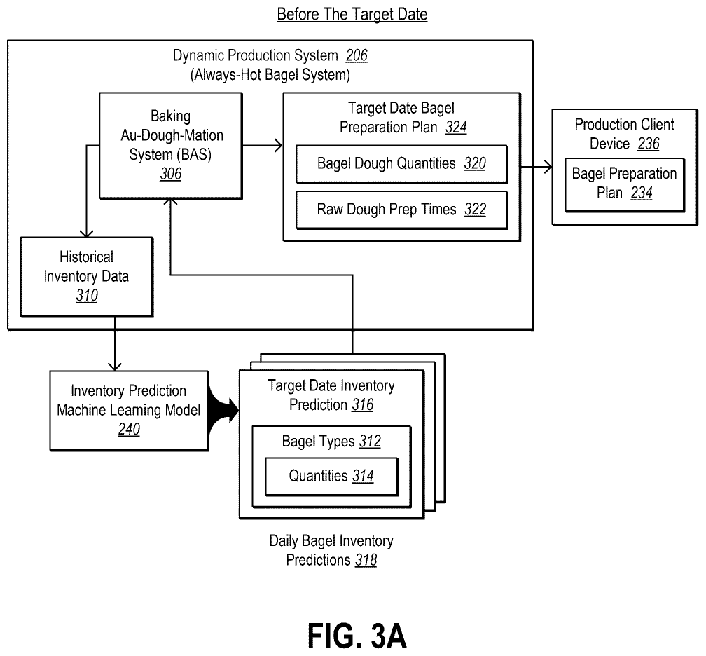

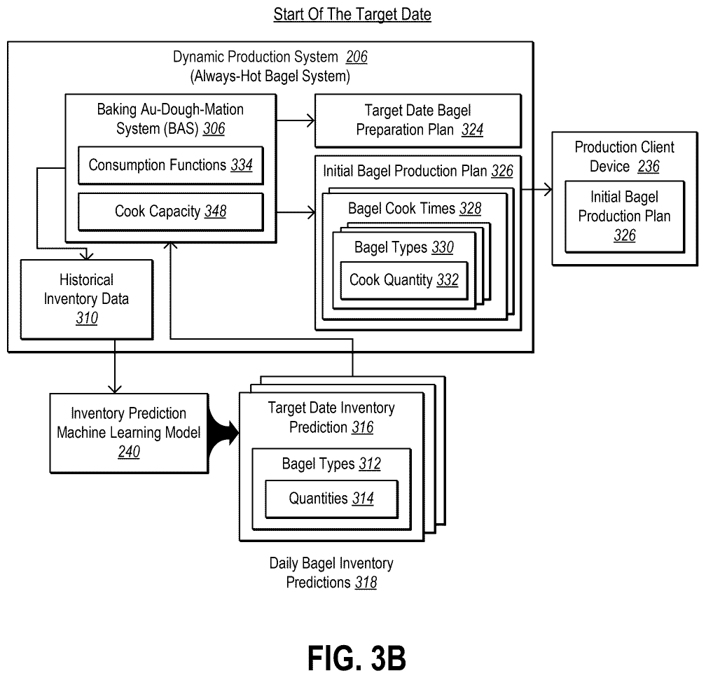

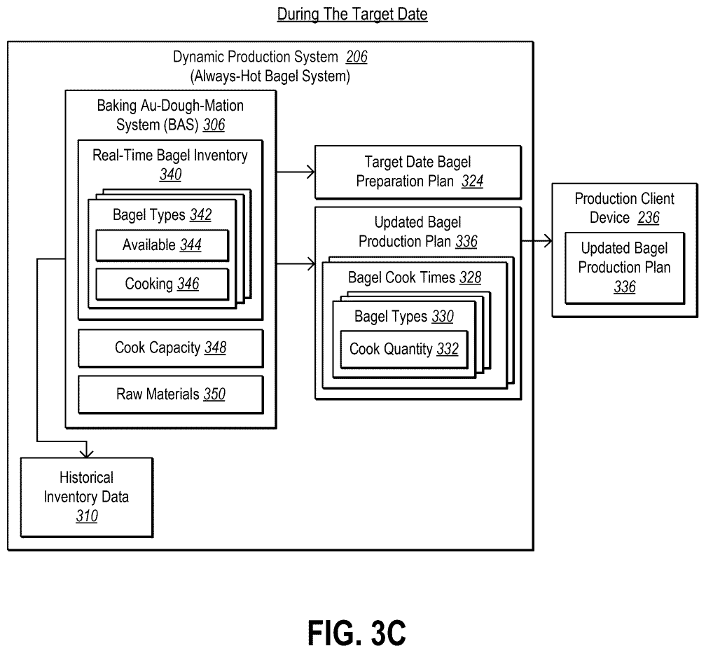

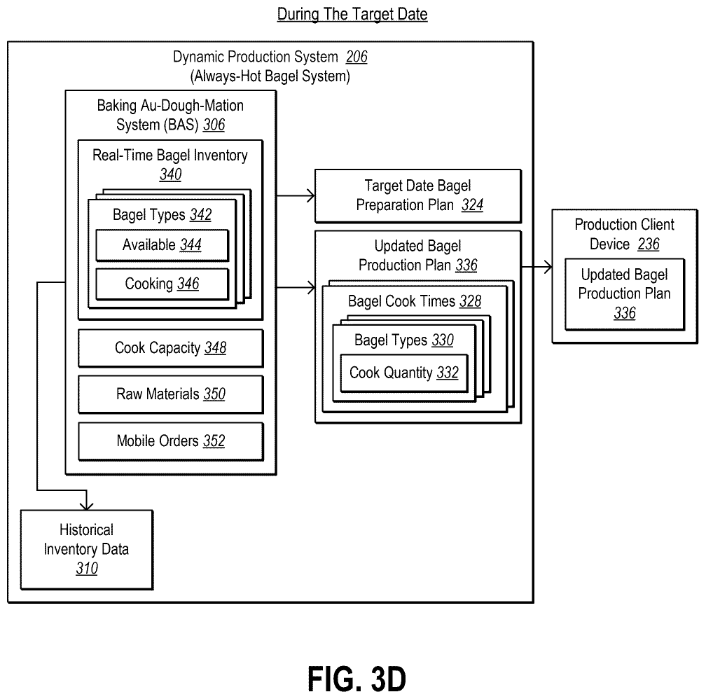

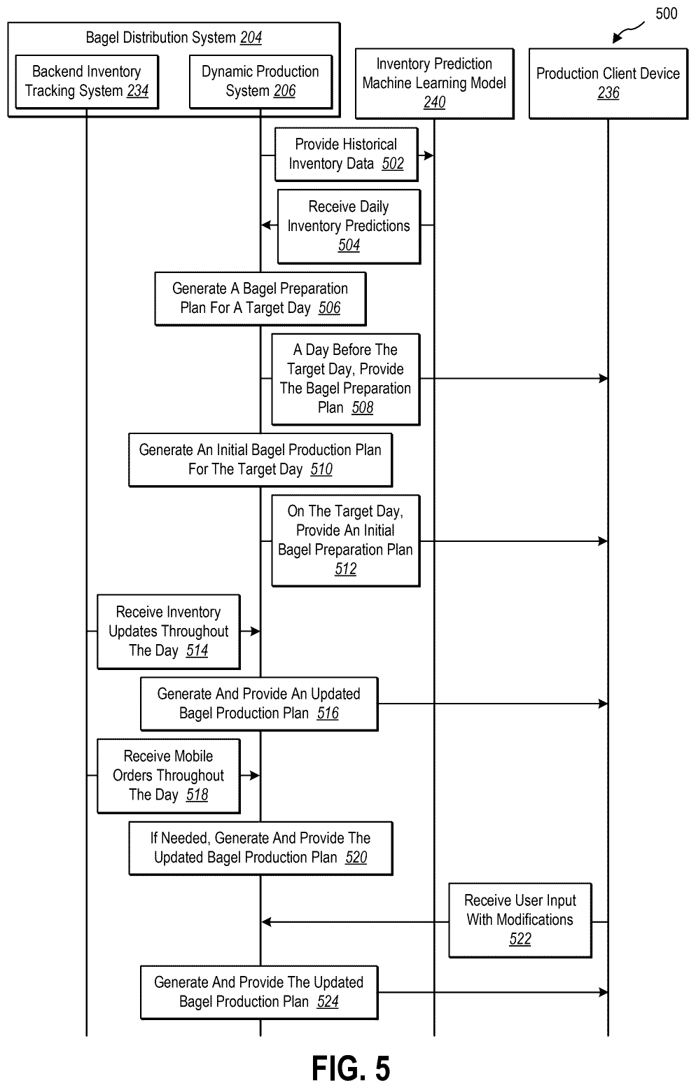

To illustrate, the series of acts 100 includes act 102 of generating a bagel inventory prediction that includes bagel type estimates for a target day using an inventory prediction model. For example, the dynamic production system uses an inventory prediction machine learning model to generate daily bagel inventory predictions that include which bagel types to make available on a target day as well as quantities for each bagel type. In various implementations, the dynamic production system provides historical inventory data to the inventory prediction machine learning model to generate bagel inventory predictions for multiple dates at a time. Additional details regarding generating bagel inventory predictions are provided below in connection with FIG. 3A and FIG. 5.

Act 104 includes generating a bagel preparation plan and an initial bagel production plan for the target day based on the bagel inventory prediction. For example, the dynamic production system generates a bagel preparation plan to initiate the first stage of bagel production before the target day. The dynamic production system also generates an initial bagel production plan based on the bagel types and quantities included in the bagel inventory prediction for the target day.

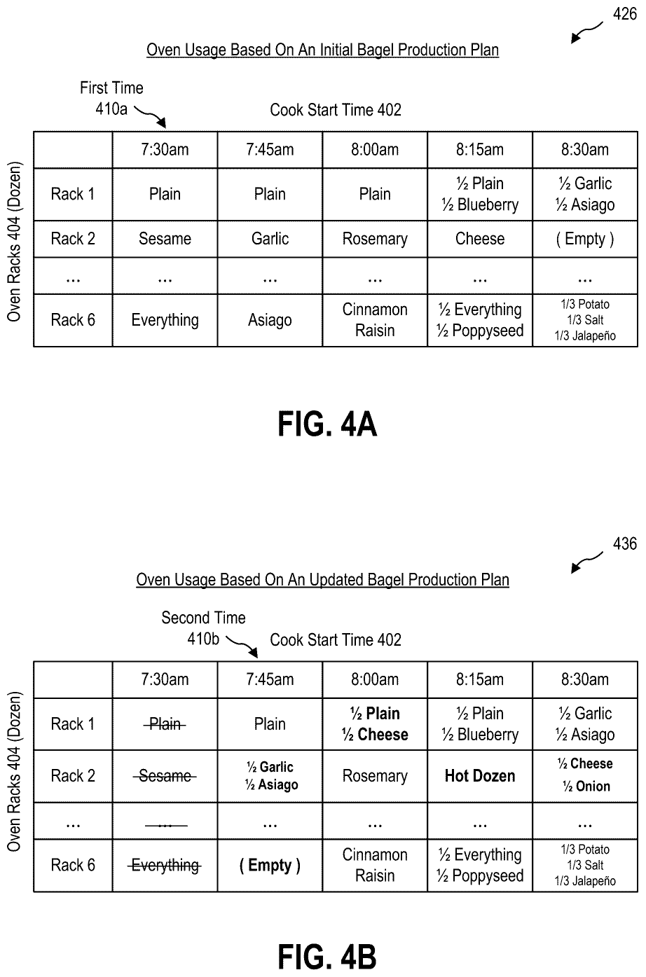

As further described below, a bagel production plan ensures oven-fresh, hot, high-quality bagels (e.g., just-in-time bagel delivery) across a variety of flavors (i.e., types) to be available at the time of order throughout the day. In various implementations, the bagel production plan includes details of when bagel batches should be prepared and cooked along with the number of each bagel type to include in a batch. In one or more implementations, the dynamic production system includes a baking au-dough-mation system (BAS) (a.k.a., a baking automation system). In some instances, the dynamic production system is another term for the BAS. Additional details regarding generating bagel preparation plans and initial bagel production plans are provided below in connection with FIG. 3B, FIG. 4A, and FIG. 5.

Act 106 includes continuously updating the bagel production plan based on real-time changes on the target day. In various implementations, as the dynamic production system (e.g., the BAS) detects changes on the target day, it generates and implements updated versions of the bagel production plan. For example, based on unexpected changes in bagel inventory data, incoming orders, customized orders, cooking equipment capacity, raw stock shortages, current staffing levels, or other changes, the dynamic production system updates the bagel production plan to seamlessly absorb these changes. Additional details regarding dynamically generating updated bagel production plans are provided below in connection with FIGS. 3C-3D, FIGS. 4A-4B, and FIG. 5.

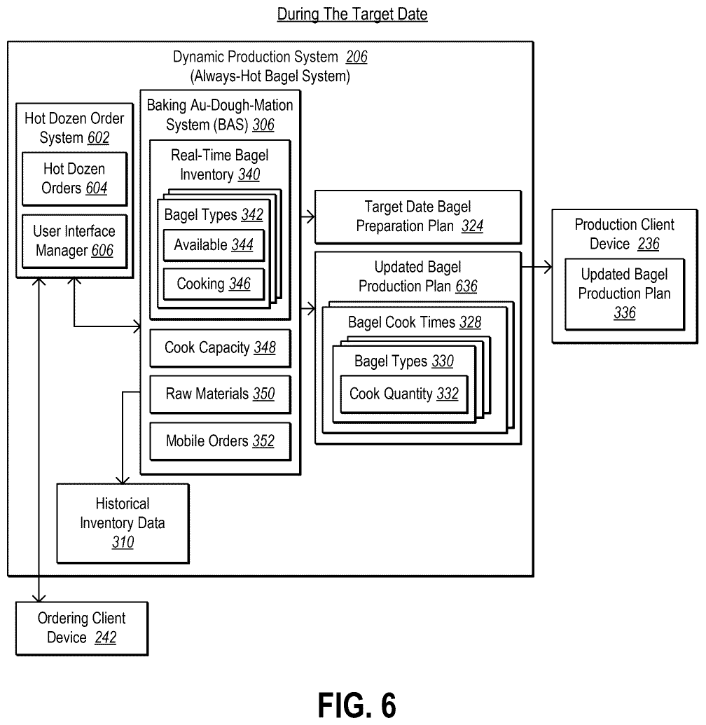

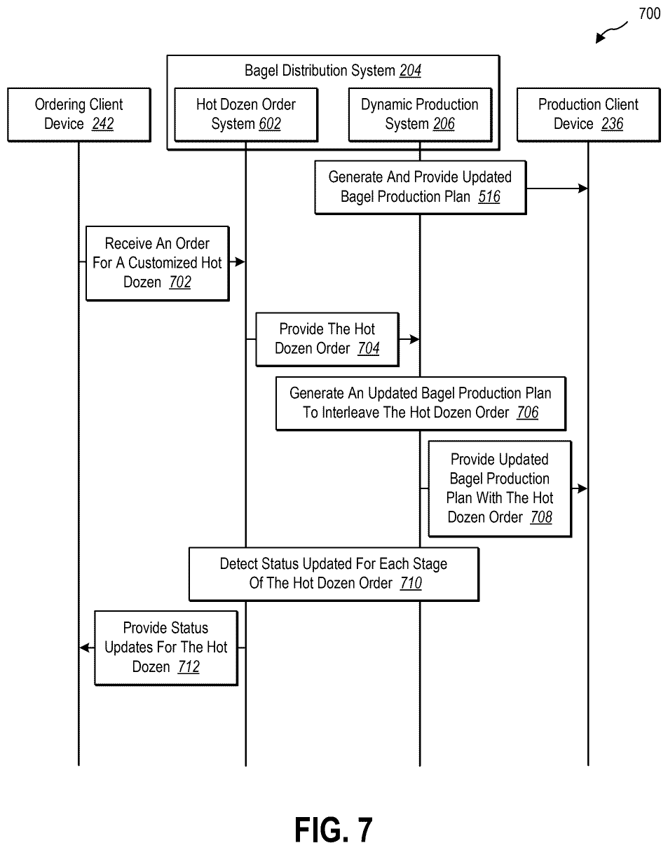

One example of a change that the dynamic production system absorbed is a customized hot dozen order (or “hot dozen” for short). For example, a hot dozen often includes a custom selection of a dozen bagels to be prepared and cooked together. To process a hot dozen, the dynamic production system determines how to efficiently rearrange other bagels scheduled to be processed and cooked at the same time, as oven rack capacity is limited. However, the dynamic production system must do more than just delay a dozen other bagels to a later time. Rather, as described below, the dynamic production system intelligently determines how to seamlessly absorb the hot dozen while not affecting other bagel production operations. Additional details regarding dynamically generating an updated bagel production plan based on customized hot dozen orders are provided below in connection with FIG. 6 and FIG. 7.

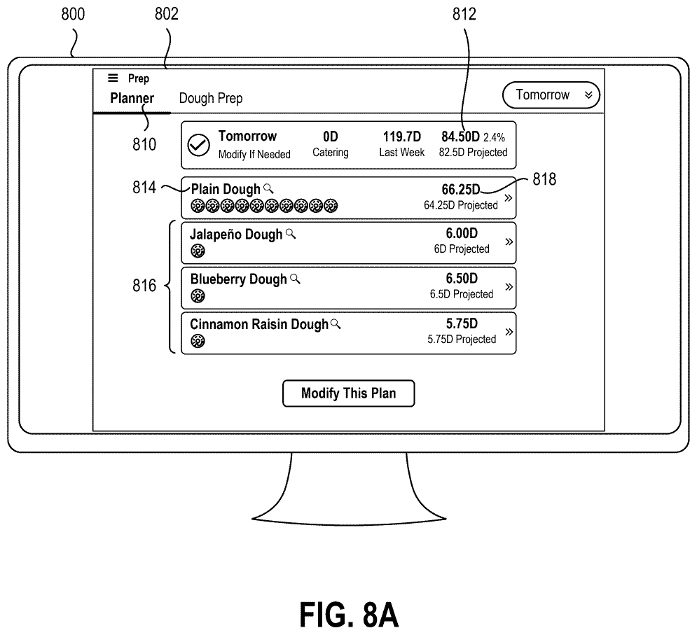

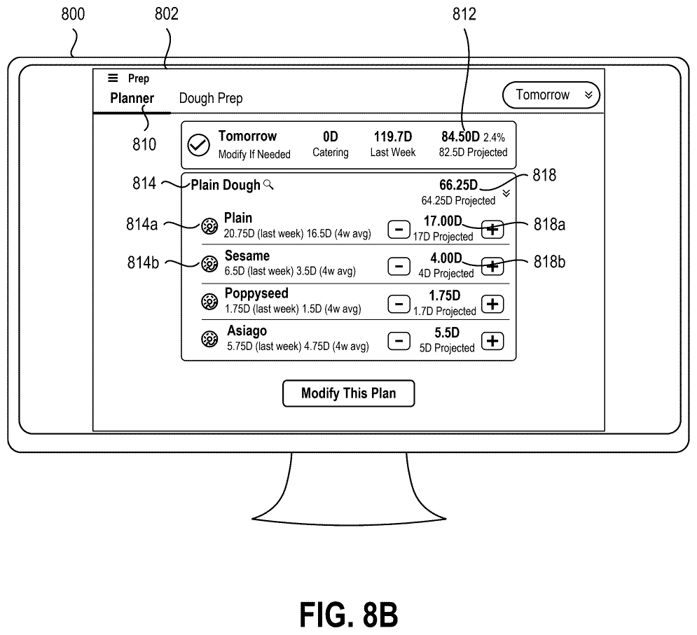

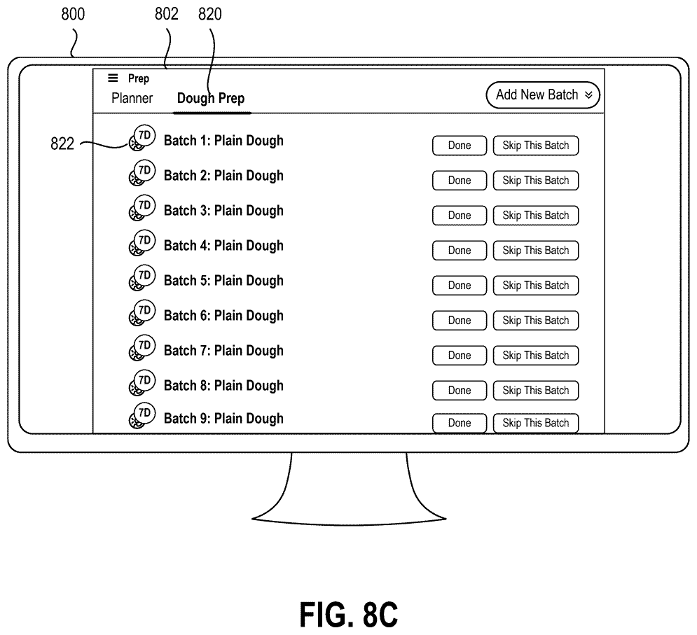

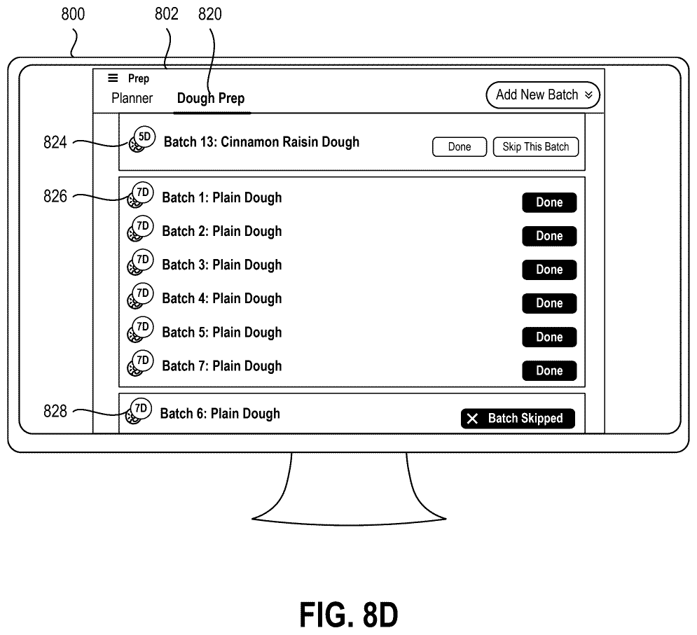

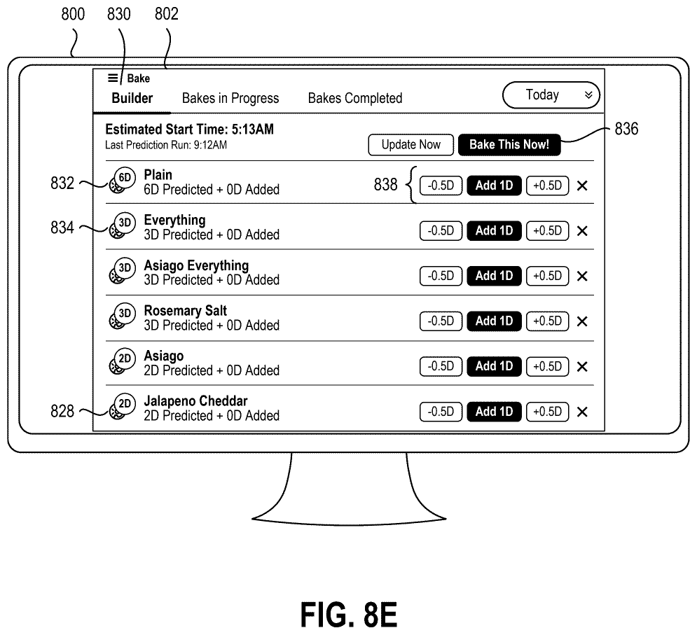

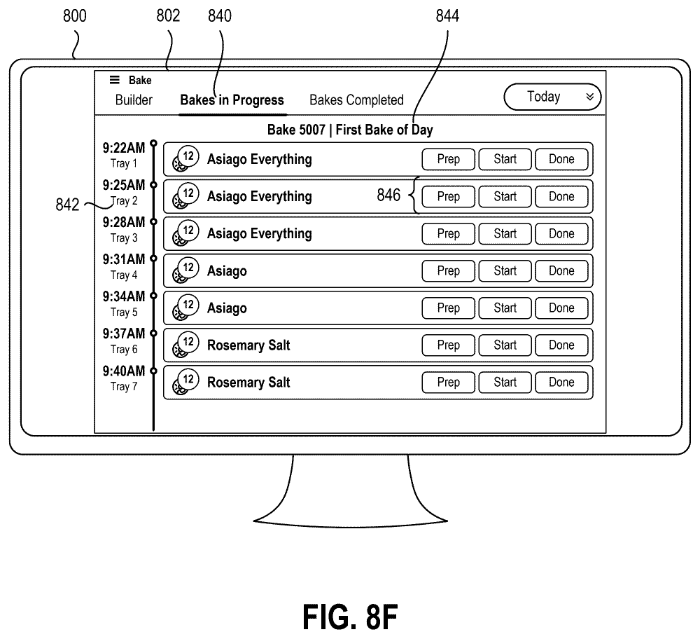

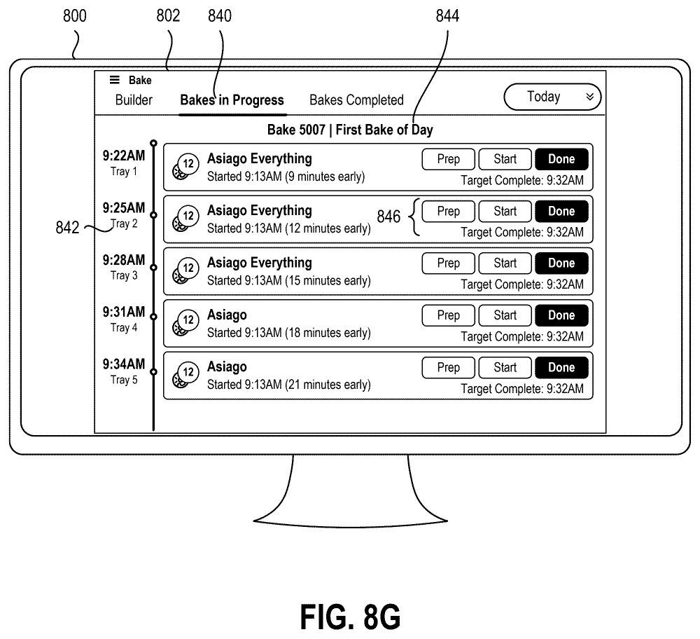

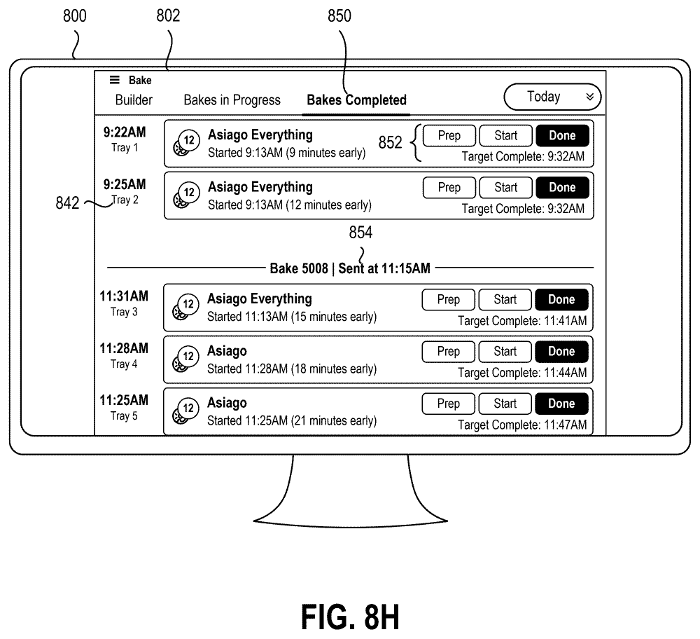

Act 108 includes providing updated versions of the bagel production plan to a client device. For example, upon updating a bagel production plan on a target day, the dynamic production system provides the updated plan to one or more client devices with implementation instructions. For instance, the updated bagel production plan includes instructions on when to boil a batch of shaped raw dough and how many of each dough type to boil (e.g., standard dough versus specialty dough), when to remove the boiled bagels and which bagels need pre-baked toppings, when to bake the batch, when to remove the batch from the oven and which bagels need post-baking toppings, and how to pack various orders of cooked bagels, among other instructions. Additional details regarding providing an updated bagel production plan are provided below in connection with FIGS. 8A-8H.

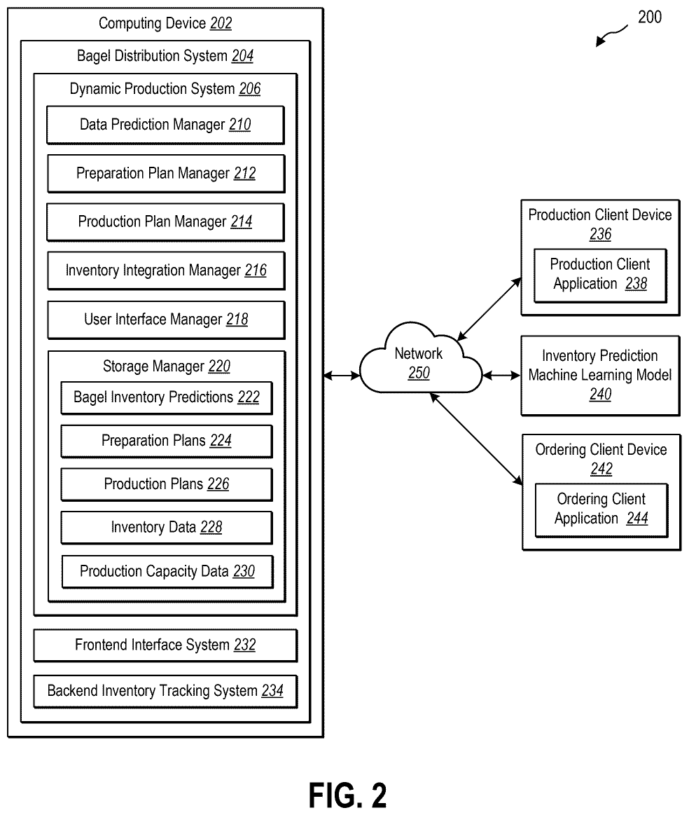

With a general overview in place, additional details are provided regarding the components, features, and elements of the dynamic production system. To illustrate, FIG. 2 shows an example computing environment where the dynamic production system is implemented according to some implementations. In particular, FIG. 2 illustrates an example of a computing environment 200 of various computing devices. In some instances, the computing environment 200 includes a computing device 202 associated with a dynamic production system 206. While FIG. 2 shows example arrangements and configurations of the computing environment 200, including the dynamic production system 206 and associated components, other arrangements and configurations are possible.

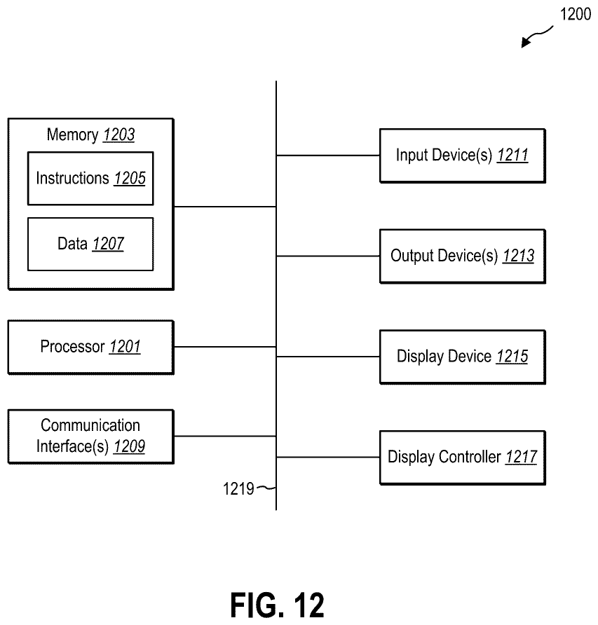

As shown, the computing environment 200 includes a computing device 202 that implements the dynamic production system 206 via a bagel distribution system 204, a production client device 236, an inventory prediction machine learning model 240, and an ordering client device 242 with an ordering client application 244, connected via a network 250. Many of these components may be implemented on one or more computing devices, such as on one or more server devices or a cloud computing system (e.g., the bagel distribution system 204 or the inventory prediction machine learning model 240. In some instances, one or more of these components may be implemented on a personal device (e.g., the production client device 236). Further details regarding computing devices are provided below in connection with FIG. 12, along with additional details regarding networks, such as the network 250 shown.

As illustrated in FIG. 2, the computing device 202 includes a bagel distribution system 204. In various implementations, the bagel distribution system 204 facilitates bagel preparation, production, orders, sales, and other tasks associated with bagel distribution. As shown, the bagel distribution system 204 implements the dynamic production system 206, a frontend interface system 232, and a backend inventory tracking system 234.

In various implementations, the frontend interface system 232 provides point-of-sale user interfaces to customers (and workers) ordering bagels (and other products) online or at brick-and-mortar stores. In some implementations, the backend inventory tracking system 234 provides backend support to the frontend interface system 232 and/or the bagel distribution system 204. For example, the backend inventory tracking system 234 tracks orders, sales, and/or other operational metrics associated with distributing bagels. While a few functions are listed, the bagel distribution system 204, the frontend interface system 232, and the backend inventory tracking system 234 may provide additional functions related to bagel distribution.

As mentioned and shown, the bagel distribution system 204 implements the dynamic production system 206. In many implementations, the dynamic production system 206 facilitates the efficient and seamless production of bagels to achieve fresh, hot bagels across a variety of bagel types throughout a given day. In some implementations, the dynamic production system 206 is located on a separate computing device from the bagel distribution system 204. In some implementations, the dynamic production system 206 is implemented within a cloud computing system. In one or more implementations, the dynamic production system 206 is implemented on one or more client devices. In various implementations, the bagel distribution system 204 operates without the dynamic production system 206.

In various implementations, including the illustrated implementation, the dynamic production system 206 includes various components and elements that are implemented in hardware and/or software. For example, the dynamic production system 206 includes a data prediction manager 210, a preparation plan manager 212, a production plan manager 214, an inventory integration manager 216, a user interface manager 218, and a storage manager 220. The storage manager 220 includes bagel inventory predictions 222, preparation plans 224, production plans 226, inventory data 228, and production capability data 230.

As mentioned, the dynamic production system 206 includes the data prediction manager 210, which utilizes the inventory prediction machine learning model 240 to generate bagel inventory predictions 222 from historical data (which may be included in the inventory data 228 or stored by the backend inventory tracking system 234). For example, the data prediction manager 210 sends a weekly, bimonthly, or monthly call to the inventory prediction machine learning model 240 with the latest historical data and receives a bagel inventory prediction for one or more days (e.g., seven to thirty days). In some implementations, the data prediction manager 210 trains and/or fine-tunes the inventory prediction machine learning model 240 using historical data and/or supervisory data that correct predictions against actual data. Additionally, while the inventory prediction machine learning model 240 is shown as a separate component, in some instances, the bagel distribution system 204 and/or the dynamic production system 206 includes some or all of the inventory prediction machine learning model 240.

The dynamic production system 206 also includes the preparation plan manager 212, which generates preparation plans 224 for different target days from the bagel inventory predictions 222 and other inputs (e.g., inventory data 228 and production capability data 230). For example, the preparation plan manager 212 provides instructions regarding the quantity of dough to prepare for each bagel type (either as separate or combined dough batches).

Additionally, the dynamic production system 206 includes the production plan manager 214, which generates the production plans 226. In various implementations, the production plan manager 214 generates initial bagel production plans for target days based on the bagel inventory predictions 222. Additionally, the production plan manager 214 also generates updated versions of the production plans 226 based on real-time inputs and changes. For example, the production plan manager 214 updates a bagel production plan based on changes to inventory data 228 and/or production capability data 230, among other potential input changes. When changes are received, the production plan manager 214 determines if the change is anticipated (e.g., already incorporated or covered by the current bagel production plan) or if the bagel production plan needs to be further updated to seamlessly absorb the change.

The dynamic production system 206 includes the inventory integration manager 216, which communicates with the backend inventory tracking system 234 to receive inventory updates. The inventory integration manager 216 may store the changes as inventory data 228 and/or provide it to the production plan manager 214 to implement in an updated bagel production plan for a target day. In some implementations, the inventory integration manager 216 also communicates with the frontend interface system 232 to receive inventory changes, such as up-to-date inventory or sales information indicating when stock of a given bagel type is low or out. Again, the inventory integration manager 216 can provide this information to the production plan manager 214, which determines if the change is anticipated or if adjustments need to be made.

Additionally, the dynamic production system 206 includes the user interface manager 218, which implements user interface updates associated with the dynamic production system 206. For example, the user interface manager 218 provides the bagel inventory predictions 222 and the preparation plans 224 to the production client device 236 for bagels to be prepared according to a bagel preparation plan or a bagel production plan.

In some implementations, the user interface manager 218 implements customized hot dozen orders. For example, the user interface manager 218 provides status updates to a user client device, such as the ordering client device 242, indicating the status of an order (e.g., a mobile order or a hot dozen order).

As shown, the computing environment 200 includes the inventory prediction machine learning model 240, which generates bagel inventory predictions 222 from historical inventory data, which may include historical sales data. In various implementations, the inventory prediction machine learning model 240 includes one or more machine learning models, neural networks, large generative models, and/or other models that generate bagel inventory predictions 222. Unlike bagel production plans, the bagel inventory predictions 222 may be generated much less frequently (e.g., weekly, bimonthly, or monthly versus hourly, every dozen minutes, every minute, or upon detecting one or more changes).

In various implementations, the dynamic production system 206 generates, trains, or otherwise obtains the inventory prediction machine learning model 240. For example, the dynamic production system 206 provides data at different intervals and instructs the inventory prediction machine learning model 240 to self-learn or self-train. In some instances, as mentioned above, the inventory prediction machine learning model 240 uses ground truth data to train and/or fine-tune the model in a supervisory manner.

As shown, the computing environment 200 includes the production client device 236 and the ordering client device 242. In some implementations, the production client device 236 is associated with users involved in bagel production while the ordering client device 242 is associated with users ordering and purchasing bagels. In some implementations, the production client device 236 and the ordering client device 242 are the same client device or include similar functionality for the dynamic production system 206.

As shown, the client devices each include client applications, shown as a production client application 238 and an ordering client application 244, respectively. In various implementations, one or more of the client applications include a web browser, mobile application, or another form of computer application for accessing and/or interacting with the computing device 202 and/or the dynamic production system 206. For example, the production client application 238 provides bagel production plans to users to prepare and cook bagels, while the ordering client application 244 enables a customer to order and track the status of a customized hot dozen order.

Turning to the next set of figures, FIGS. 3A-3D, FIGS. 4A-4B, and FIG. 5 illustrate examples of block and sequence diagrams that focus on different aspects of the dynamic production system 206 generating bagel preparation plans and bagel production plans, and updated bagel production plans in particular. Additionally, these figures show how the dynamic production system 206 performs different actions at different times before and during a target day (e.g., the day when the bagels are to be cooked and distributed and/or sold).

To begin, FIG. 3A illustrates an example block diagram of the dynamic production system creating a bagel preparation plan before a target day according to some implementations. As shown, FIG. 3A includes the dynamic production system 206 (e.g., an always-hot bagel system) and the inventory prediction machine learning model 240. FIG. 3A is also set before a target day.

The dynamic production system 206 includes a baking au-dough-mation system (BAS 306) (a.k.a., a baking automation system). In some implementations, the BAS 306 is the core component of the dynamic production system 206. In some instances, the BAS 306 is an alias for or performs the same functions as the dynamic production system 206. In either case, actions performed by the BAS 306 are included as actions performed by the dynamic production system 206.

As shown, the BAS 306 provides historical inventory data 310 to the BAS 306. In some implementations, the BAS 306 gets the historical inventory data 310 from a database maintained by a bagel distribution system and/or the dynamic production system 206. In various implementations, the historical inventory data 310 includes prior inventory data that includes quantities produced and/or sold for multiple bagel types (e.g., historical sales performance per product or item type).

The historical inventory data 310 may also include additional information. In some implementations, the historical inventory data 310 includes preparation and/or transaction information (e.g., transaction times, amounts, and/or other transaction details). In some implementations, historical inventory data 310 includes location information and regional information. In some implementations, the historical inventory data 310 includes production information, such as kitchen equipment capacity and/or production man-hours.

In some implementations, the BAS 306 provides prompts or commands to the inventory prediction machine learning model 240 regarding the expected output. For example, the BAS 306 provides the sales data along with a list of bagel types scheduled to be served on a given day. The inventory prediction machine learning model 240 then provides an output corresponding to the provided bagel types.

Using the historical inventory data 310, the inventory prediction machine learning model 240 generates daily bagel inventory predictions 318. For instance, the inventory prediction machine learning model 240 models and predicts future inventory expectations per bagel type (e.g., future sales performance per product item). In various implementations, the daily bagel inventory predictions 318 include daily predictions for multiple future dates, such as 7 days, 14 days, 20 days, 30 days, or 60 days. Because the inventory prediction machine learning model 240 generates daily bagel inventory predictions 318 for multiple days, the BAS 306 can call it less frequently (e.g., once per week, bimonthly, or monthly). By calling the inventory prediction machine learning model 240 less frequently, the BAS 306 minimizes computer processing waste and improves efficiency.

As shown, the daily bagel inventory predictions 318 include target date bagel inventory predictions 316 for a target date, which include bagel types 312 and quantities 314 for the bagel types 312. For example, the bagel types 312 include each type (e.g., flavor) of bagel that should be in the inventory for the target date, and the quantities 314 indicate how many bagels (counted individually, in dozens, or by another number) for each bagel type.

In one or more implementations, the daily bagel inventory predictions 318 reveal non-intuitive trends or patterns among bagel types and quantities. For example, Bagel Type A may have better sales on a particular weekday, or two bagel types may be unexpectedly correlated. Indeed, the daily bagel inventory predictions 318 may provide the BAS 306 with insights that allow it to add further efficiencies to the bagel production process.

In various implementations, the inventory prediction machine learning model 240 obtains external data to assist in determining the daily bagel inventory predictions 318. For example, when processing the historical inventory data 310 for a previous day, the inventory prediction machine learning model 240 considers the location, region, day of the week, weather, holiday schedule, news events, promotions, sales of complementary items, and/or other factors that may have influenced inventory data. Then, when modeling and predicting the daily bagel inventory predictions 318 for future dates, the inventory prediction machine learning model 240 obtains and incorporates the same influences and factors into its predictions. In some implementations, the BAS 306 feeds in one or more additional inputs for the inventory prediction machine learning model 240 to consider (e.g., an upcoming event or an unexpected weather forecast).

As shown, the BAS 306 receives the daily bagel inventory predictions 318 including the target date bagel inventory predictions 316 from the inventory prediction machine learning model 240. Using the daily bagel inventory predictions 318, the BAS 306 can optimize tray scheduling by generating one or more bagel preparation plans. In particular, using the target date bagel inventory predictions 316, the BAS 306 generates a target date bagel preparation plan 324, as shown.

As mentioned above, bagel production is often a multi-day process with precise timing requirements. For example, bagels being distributed on a target date need to be prepared a day in advance to allow proper chemical processes to occur. Accordingly, the target date bagel preparation plan 324 includes quantities and instructions for preparing raw dough before the target date.

To elaborate, in various implementations, the BAS 306 generates the target date bagel preparation plan 324, which includes bagel dough quantities 320 and raw dough prep times 322. For example, the target date bagel preparation plan 324 includes the number or amount of bagels to mix and prepare for each bagel type based on processing the predictions in the target date bagel inventory predictions 316. In some instances, the BAS 306 uses the bagel types 312 and the quantities 314 included in the target date bagel inventory predictions 316. In some implementations, the BAS 306 uses the target date bagel inventory predictions 316 as a baseline for determining the bagel dough quantities 320 (or the number of each bagel type).

In various implementations, the target date bagel preparation plan 324 groups multiple bagel types together when providing the bagel dough quantities 320. For example, if multiple bagel types use a plain or standard dough, the bagel dough quantities 320 group these bagel types together, as they all undergo the same mixing and raw dough preparation process. In these instances, the bagel dough quantities 320 include a sub-listing of bagel types and their quantities included in the combined bagel type quantity. In some instances, each bagel type is listed as a separate quantity. In some implementations, the bagel dough quantities 320 include a separate quantity for each bagel type that requires a specialty dough (e.g., a specialized bagel dough).

In addition, the target date bagel preparation plan 324 includes the raw dough prep times 322. In various implementations, the raw dough prep times 322 include a schedule for mixing, proofing, rolling, and/or other raw dough production steps for each bagel or dough type.

Additionally, as shown, the BAS 306 provides the target date bagel preparation plan 324 to the production client device 236. For example, the BAS 306 provides the target date bagel preparation plan 324 to a client application on the production client device 236, which displays it to a user making the raw bagel dough.

In some cases, the BAS 306 incorporates dough roller optimization into the target date bagel preparation plan 324. To elaborate, while bagel dough largely needs to be mixed at least a day in advance to allow for a bulk fermentation stage to develop flavor and structure, the prepared dough may be kept for more than one day. For example, dough may be stored for up to two days while still maintaining its optimal qualities. Accordingly, after being mixed and rolled, bagel dough can be used on the original target date or the day after the target date.

Dough roller optimization provides additional flexibility to the BAS 306. For example, the BAS 306 may overestimate, or error on the side of preparing too much dough, for a target date to accommodate an unexpectedly higher demand. If not needed, the rolled dough may be used the next day without creating excess waste. Indeed, the target date bagel preparation plan 324 may include an overflow stock amount for each dough type to serve as a demand buffer for a target date.

In these implementations, the BAS 306 factors in any dough roller into both target date bagel preparation plans and bagel production plans. For instance, based on the amount of unused dough for a given day, the BAS 306 adjusts the quantities for the next target date and/or the following target date. For example, if more dough was prepped than was needed for Day 1, the BAS 306 allocates those raw prepared bagels into Day 2's plans and Day 3's plans (because Day 2's dough preparation may need to begin before Day 1's rollover stock is known). In this way, the BAS 306 reduces the total new raw dough that needs to be mixed and prepared for the future target dates using dough roller optimization. Likewise, if more bagels were baked than planned for a given day, the BAS 306 increases the amount of dough to be prepared for the next target date and/or the following target date to restore the extra stock quantity to the overflow stock amount.

In some instances, the overflow stock amount is a range (e.g., four to six dozen). This allows the BAS 306 to optimize bagel preparation plans given the uncertainty of how the overflow stock amount will remain on a given day (e.g., because dough preparation for the next target date may need to begin a current date's rollover stock is known) while also absorbing the uncertainty within the bagel preparation plan of the following date.

Moving to FIG. 3B, this figure focuses on the start of the target date. However, the actions described can occur at any time before or at the start of the target date. FIG. 3B includes the same elements as in FIG. 3A, such as the dynamic production system 206, the BAS 306, and the inventory prediction machine learning model 240. For convenience, FIG. 3B includes the inventory prediction machine learning model 240 generating the daily bagel inventory predictions 318 from the historical inventory data 310 and providing them to the BAS 306, along with the BAS 306 generating the target date bagel preparation plan 324, which occurs before the target date.

As illustrated, the BAS 306 generates an initial bagel production plan 326 for the target date at or before the start of the target date. The initial bagel production plan 326 includes bagel cook times 328 for bagel types 330 and cook quantities 332. For example, the bagel cook times 328 indicate how many of each bagel type to include in a cooking batch. A batch may include a dozen, two dozen, or more bagels to be prepared and cooked. As mentioned earlier, in some implementations, the initial bagel production plan 326 corresponds to tray scheduling and/or tray optimization.

Additionally, the bagel cook times 328 can include multiple cooking steps. For instance, the bagel cook times 328 can include times (or windows of time) for rising, boiling, pre-baked topping, baking, post-baked toppings (if needed), packaging, and/or other cooking steps. Each step may include a start time, countdown timer, and/or finish time.

As shown, the BAS 306 includes consumption functions 334. In some instances, the BAS 306 generates the consumption functions 334 from tracked inventory, the historical inventory data 310, and/or other bagel production metrics. For example, the BAS 306 utilizes consumption functions 334 associated with anticipated or future demand, product preparation time, product ingredients, and anticipated staffing levels. In various implementations, the BAS 306 includes a separate consumption function for each bagel type. In some implementations, a consumption function applies to multiple bagel types.

The BAS 306 can use the consumption functions 334 and/or other models or curves to allocate the distribution of each bagel type across the target date. For instance, the BAS 306 divides the target date into time intervals (e.g., 8-minute, 10-minute, or 15-minute intervals) and for each bagel type, the BAS 306 determines how many bagels to serve within each time interval based on a consumption function. In some implementations, the BAS 306 allocates the number of bagels planned for a given bagel type across the time intervals based at least on a consumption function associated with the bagel type.

In some instances, the consumption functions 334 implement scaler and reduction functions. For example, during a target date, the BAS 306 applies one or more processes that analyze consumption during the target date as a whole. Based on identified consumption patterns and rates, the BAS 306 adjusts (sometimes significantly) the bagel production plan by scaling quantities for one or more bagel types up or down. As described below, the BAS 306 can dynamically adjust the bagel production plan during the target date based on the modified bagel production plan.

With the bagel types allocated across the target date, the BAS 306 may determine a bagel production plan (e.g., tray scheduling or tray optimization) that balances the allocations with cooking capacity 348. For example, the BAS 306 is provided with cooking constraints, such as the number of bagels that fit on a tray, the number of available cooking trays, the size of a tray rack, the number of trays in an oven, the number of ovens, the size of a boiling kettle, and/or other cooking limitations. The BAS 306 applies constraints of the cooking capacity information when generating a bagel production plan to ensure a high percentage of fresh, hot bagels.

For example, if only 6 dozen (or 72 bagels) can be baked at a time (e.g., a baking batch), and the total number for the same time interval is determined to be 80 bagels, then the BAS 306 intelligently determines how to reallocate 8 bagels to a previous and/or later time interval. For instance, the BAS 306 determines whether to reallocate 8 of the same bagel type or to split the reallocation across different bagel types. Furthermore, reallocating for a given time interval may cause other time intervals to also be reallocated until an optimal solution is determined.

Additionally, the BAS 306 must do this while also ensuring that bagels are fresh and hot upon delivery or purchase, rather than delivering a staling, reheated bagel. As mentioned multiple times, an aim of the BAS 306 is to ensure that a cooked bagel is sold fresh and hot. In some instances, fresh and hot equates to delivering (or selling) a bagel before it ages since it completed cooking passes a freshness threshold time (e.g., 5 minutes, 10 minutes, or 15 minutes). In some instances, the BAS 306 employs multiple levels of quality and freshness using multiple freshness thresholds (e.g., a first freshness threshold of 10 minutes for optimal quality bagels, a second threshold of 30 minutes for fresh, high-quality bagels, and a third threshold of over 60 minutes for fresh, acceptable-quality bagels). In some cases, the BAS 306 generates bagel production plans that follow a distribution of how many bagels can be in each freshness category (e.g., 80% or more in the optimal-quality threshold, 15% or less in the high-quality threshold, and 5% or less in the acceptable-quality threshold), which can reduce waste.

Upon determining an ideal distribution of bagel types and their quantities for each time interval, the BAS 306 can assign bagels in a time interval to one or more bagel cook times. In some instances, the BAS 306 works backward by assigning a bake time 11-15 minutes before the ready time and a boil time 3 minutes prior. The BAS 306 can compile each cook time with the corresponding bagel types and their quantities into an initial bagel production plan 326.

As shown, the initial bagel production plan 326 includes bagel cook times 328 for bagel types 330 and cook quantities 332 for each of the bagel types. In various implementations, the bagel cook times 328 represent an ideal bagel production plan that properly accounts for customer demand and all components and equipment functioning properly. It also serves as the foundation for updated bagel production plans generated throughout the target day.

FIG. 3B shows the BAS 306 providing the initial bagel production plan 326 to the production client device 236. In various implementations, users follow the initial bagel production plan 326 to make initial preparations for bagel production on the target day, such as preparing trays with raw rolled dough ready to be baked or further processed at times specified in the initial bagel production plan 326.

Moving to FIG. 3C, this figure transitions to bagel production during the target date. For convenience, the inventory prediction machine learning model 240 and corresponding elements have been removed as the BAS 306 is now responding to real-time changes. FIG. 3C still includes the BAS 306 within the dynamic production system 206.

As illustrated, the BAS 306 generates an updated bagel production plan 336 for optimizing tray scheduling. For example, as the target day progresses and real-time data is received regarding inventory changes and movement, the BAS 306 ingests these updates and seamlessly absorbs them into an updated bagel production plan 336. For example, inventory changes and movement can include changes in cooking, cooking delays, sold stock, available fresh bagels, unavailable bagels, frontend information, and/or backend data. For instance, as described elsewhere, the BAS 306 generates an updated bagel production plan 336 based on future item demand, item preparation time, current inventory levels, oven capacity, time of day, item ingredients, item baking difficulty, item freshness period, current staffing levels, dough availability, item popularity, and/or other factors that change throughout the day.

To illustrate, FIG. 3C shows that the BAS 306 includes a real-time bagel inventory 340 (e.g., current sales for the target day) with availability 344 and cooking 346 statuses for each of the bagel types 342. In various implementations, the BAS 306 tracks status updates or receives them from a bagel distribution system (e.g., a frontend interface system and/or a backend inventory tracking system). The BAS 306 also includes statuses for cooking capacity 348 and raw materials 350.

In one or more implementations, the inventory changes are based on a user (e.g., a baker) manually modifying the bagel production plan for a given time. In response, if the changes are significant enough to warrant an updated bagel production plan, the BAS 306 applies the change to future time intervals in the bagel production plan. For example, if the BAS 306 detects a baker adding an additional dozen of plain bagels for Time Interval 3, the BAS 306 may reduce the number of plain bagels scheduled for Time Interval 4 and/or Time Interval 5.

In various implementations, when an inventory change is detected or identified, the BAS 306 determines if the changes warrant updating the current bagel production plan. If not, the BAS 306 continues to provide the current bagel production plan to the production client device 236 (or to multiple devices). Otherwise, the BAS 306 begins to modify the bagel production plan based on the change.

As an example, if the identified change is that a particular bagel type is being ordered faster than anticipated, the BAS 306 may modify the bagel production plan to increase the quantity of that bagel type being produced across one or more time intervals. Similarly, the BAS 306 may modify other bagel types throughout the day in response to orders earlier in the day. In one or more implementations, the BAS 306 determines that a bagel type matches up with a different consumption curve and may update the bagel production plan by applying the better matching consumption curve to the bagel type for the rest of the day.

As explained before, each modification to a time interval in the bagel production plan may have implications for later intervals (or previous intervals if the change is far enough in the future). Accordingly, the BAS 306 intelligently and dynamically makes the necessary adjustments to maximize bagel freshness, minimize waste, and satisfy cooking equipment constraints (e.g., the cooking capacity 348).

As mentioned above, in some instances, many of the bagel types share the same base dough (e.g., a plain or standard dough). Accordingly, in these instances, the BAS 306 may adjust the bagel production plan by adding more bagels of a first bagel type and removing some bagels of a second bagel type as long as there are sufficient amounts of the raw materials 350 to make more bagels of the first bagel type (e.g., pre-and post-baking toppings).

As mentioned above, in various implementations, the BAS 306 utilizes dough roller optimization. In these implementations, the BAS 306 may first access an overflow stock before needing to reallocate other bagel types that share the same base dough. However, the BAS 306 may otherwise determine to reallocate other bagel types based on other factors. Additionally, the BAS 306 need not worry about wasting unused prepared dough, which can be rolled over and used on the next target day.

As shown, the updated bagel production plan 336 includes the bagel cook times 328 with bagel types 330 and quantities 332. In some instances, the updated bagel production plan 336 indicates changes from a previous bagel production plan. In various implementations, the updated bagel production plan 336 replaces the future bagel cook times 328 information with the updated data.

Upon generating the updated bagel production plan 336 (e.g., updated tray scheduling), the BAS 306 provides it to the ordering client device 242. This way, the updated bagel production plan 336 replaces the initial bagel production plan 326 and provides updated instructions to follow for the remainder of the target date.

Moving to FIG. 3D, this figure also corresponds to the dynamic production system 206 and/or BAS 306 dynamically operating during the target date. In particular, FIG. 3D focuses on the BAS 306 receiving mobile orders 352 during the target date. In some instances, a frontend interface system facilitates customers in submitting mobile orders for immediate delivery or for a future time within the target date.

Upon receiving a mobile order, in various instances, the BAS 306 determines whether the order can be fulfilled without deviating from the current bagel production plan. In many cases, the bagels included in the mobile order have been anticipated within the current bagel production plan. In these cases, the BAS 306 may keep the current bagel production plan and deliver oven-fresh bagels at the time of order pickup (e.g., just-in-time bagel delivery). In other cases, to accommodate the mobile order, especially for a future order, the BAS 306 determines to adjust the bagel production plan to ensure that the bagel types included in the mobile order are oven-fresh at the time of order pickup.

As provided above, when updating the bagel production plan, the BAS 306 may dynamically reallocate and rearrange which bagels are included in which cook times. In some instances, such as later in the day, the BAS 306 can add additional bagels to accommodate a customized order without needing to reallocate other bagels as there is spare or available cooking capacity for that time interval.

In some implementations, larger orders are received, such as catering orders. As with other orders, the BAS 306 adjusts the bagel production plan to accommodate these orders. In some cases, if the order is sufficiently large or needs to be ready during a busier time, the BAS 306 adds additional time intervals to the bagel production plan. For example, for a large morning order of 20 dozen, the BAS 306 may include additional time to recreate the initial bagel production plan to start earlier to fulfill the large order. In some instances, the BAS 306 prepares large orders to be fresh, but not oven-fresh or piping hot, as it does with normal in-store and mobile orders.

FIGS. 4A-4B illustrate example tables associated with a bagel production plan and an updated bagel production plan to facilitate optimized tray scheduling according to some implementations. The tables are used to show how modifying a bagel production plan may result in changes to which bagel types are baked in an oven at different scheduled cook times. In both figures, the table includes cook start times 402 along the horizontal axis and oven racks 404 along the vertical axis. In these examples, the oven includes 6 racks, with each rack capable of holding a tray with a dozen bagels.

As illustrated, the initial table 426 in FIG. 4A corresponds to oven usage based on an initial bagel production plan, and the updated table 436 in FIG. 4B corresponds to oven usage based on an updated bagel production plan. Additionally, the initial table 426 shows a first time 410a around 7:30 am, and the updated table 436 shows a second time 410b around 7:45 am.

As described above, the dynamic production system 206 (e.g., a BAS) determines the initial bagel production plan at the start or before a target date. As shown, the initial table 426 includes an initial bagel production plan where various single dozens, one-half dozens, and one-third dozens are scheduled to be baked. The bagel production plan allocates different bagel types with their determined quantities to different cook start times. In various implementations, the bagel production plan indicates which bagels go on which rack or tray. In some implementations, the bagel production plan includes adding a bagel type with a single bagel to a cook start time.

FIG. 4B shows the updated table 436 later in the morning at the second time 410b, which corresponds to an updated bagel production plan. For example, the dynamic production system 206 detects one or more real-time changes and dynamically updates the bagel production plan to absorb the changes. For convenience, the changes are shown in bold. The updated table 436 also crosses out the 7:30 cook start time as it has passed and cannot be changed.

As shown, the bagel types and quantities have shifted between the initial table 426 and the updated table 436. For example, the 7:45 am cook start time reduces the garlic dozen and asiago dozen to half-dozens. The 8:11 am cook start time in the updated table 436 also adds a hot dozen. In response to adding a hot dozen (a customized order of 12 oven-fresh bagels of one or more bagel types), the dynamic production system 206 moves half of the cheese dozen up a time slot and the other half dozen back a time slot. These examples are merely illustrative of the dynamic production system 206 making and implementing changes to a bagel production plan in response to real-time changes.

Additionally, the cook start time in the updated table 436 changes from the initial table 426. For example, the BAS 306 determines that one or more of the trays are empty at the 7:30 am cook start time. When fewer trays are cooked together, the cooking time may be shortened (e.g., 6 trays take 14 minutes to cook while 4 trays cook in 11 minutes). Accordingly, as shown, the updated bagel production plan dynamically modifies the cook start times 402 in the updated table 436, which improves the efficiency of the bagel production process.

FIG. 5 illustrates an example sequence diagram of the dynamic production system updating a bagel production plan throughout a given day based on various factors according to some implementations. FIG. 5 shows communications between various components introduced above and provides an example sequence of communications. In particular, FIG. 5 shows the bagel distribution system 204 with the backend inventory tracking system 234 and the dynamic production system 206, the inventory prediction machine learning model 240, and the production client device 236.

As shown, FIG. 5 includes a series of acts 500 performed by or for the dynamic production system 206. The series of acts 500 starts with act 502 of the dynamic production system 206 providing historical inventory data to the inventory prediction machine learning model 240. In some implementations, the backend inventory tracking system 234 or another system provides the historical inventory data to the inventory prediction machine learning model 240.

Act 504 includes the dynamic production system 206 receiving daily inventory predictions. As described above, the inventory prediction machine learning model 240 uses modeling to generate predictions regarding which bagel types and how many (e.g., quantities) are estimated to be ordered (e.g., sold) on one or more particular dates.

Act 506 includes the dynamic production system 206 generating a bagel preparation plan for a target date. For example, as described above, the dynamic production system 206 uses the inventory predictions for a target date to determine a bagel preparation plan that includes bagel dough quantities and raw dough preparation times among other pieces of data.

Act 508 includes the dynamic production system 206 providing the bagel preparation plan to the production client device 236 (or multiple client devices) a day before the target date. For example, the bagel preparation plan includes instructions on starting the bagel production before the target date, such as mixing, rolling, and proofing one or more types of raw bagel dough, as described above.

Act 510 includes the dynamic production system 206 generating an initial bagel production plan for the target day. For example, as explained earlier, for each bagel type, the dynamic production system 206 uses the inventory prediction for the target day, one or more models or functions (e.g., consumption functions), cooking constraints, and/or other data to generate an initial bagel production plan for the target date.

Act 512 includes the dynamic production system 206 providing the initial bagel production plan to the production client device 236 on the target date. As provided earlier, the initial bagel production plan provides multiple cook times for cooking batches of bagels, where each cook time indicates how many of which bagel type to cook (e.g., prep, boil, bake, or pack).

Act 514 includes the dynamic production system 206 receiving inventory updates throughout the day from the backend inventory tracking system 234. For example, the backend inventory tracking system 234 provides regular sales and/or transaction updates. In response, the dynamic production system 206 generates an updated bagel production plan, as shown in act 516. Act 516 also shows the dynamic production system 206 providing the updated bagel production plan to the production client device 236 to display the updates for future time intervals, as described above.

Act 518 includes the dynamic production system 206 receiving mobile orders throughout the day from the backend inventory tracking system 234 (or another system). In response, the dynamic production system 206 determines if changes to the bagel production plan are needed, as described earlier. If needed, the dynamic production system 206 generates and provides the updated bagel production plan to the production client device 236, as shown in act 520 and described above.

Act 522 includes the dynamic production system 206 receiving user input with modifications from the production client device 236. For example, a baker adds a dozen of one bagel type or removes a half-dozen of another bagel type from a time interval. As described above, the dynamic production system 206 can seamlessly absorb these changes into an updated bagel production plan. Additionally, act 524 includes the dynamic production system 206 generating and providing the updated bagel production plan to the production client device 236.

FIG. 6 and FIG. 7 illustrate how the dynamic production system 206 implements and adapts to customized hot dozen orders (hot dozens). One feature of a hot dozen is that all twelve (or another number of bagels) are oven-fresh at the same time. Generally, this means that a hot dozen is cooked together in the same oven or on the same tray. In some cases, the bagels in a hot dozen may be cooked concurrently in different ovens and ready within a hot dozen ready threshold (e.g., 5 or 10 minutes).

Because a hot dozen is ready at the same time, in many implementations, the dynamic production system 206 cannot fulfill the order with an existing bagel production plan. Instead, a hot dozen often requires the dynamic production system 206 to generate an updated bagel production plan to accommodate cooking the hot dozen. Thus, unlike mobile orders or other incoming orders where a current bagel production plan may be able to fulfill the order without modifying the current bagel production plan, a new hot dozen order will cause a bagel production plan to be updated in most situations.

To illustrate, FIG. 6 shows an example block diagram of how interleaving hot dozen orders into the dynamic production system affects a bagel production plan according to some implementations. FIG. 6 builds upon some of the concepts and elements described above in connection with FIGS. 3A-3D. For example, FIG. 6 also includes the dynamic production system 206 (e.g., the always-hot bagel system) with the BAS 306 as shown in FIG. 3D.

FIG. 6 adds the hot dozen order system 602 with hot dozen orders 604 and a user interface manager 606. In some instances, the hot dozen order system 602 is part of the BAS 306. In some implementations, the hot dozen order system 602 is located within a bagel distribution system outside of the dynamic production system 206. FIG. 6 also adds the ordering client device 242.

In various implementations, the ordering client device 242 uses the user interface manager 606 of the hot dozen order system 602 to submit a hot dozen order. The hot dozen order system 602 provides it to the BAS 306, which generates an updated bagel production plan 636 and provides it to the production client device 236 to ensure that the hot dozen order is processed and delivered on time.

In various implementations, as the hot dozen order is being processed, the hot dozen order system 602 (e.g., via the user interface manager 606) can provide status updates to the ordering client device 242. For example, the hot dozen order system 602 indicates when the order is being prepped, boiled, baked, packed, and ready.

FIG. 7 illustrates an example sequence diagram of interleaving hot dozen orders into the dynamic production system according to some implementations. To illustrate, FIG. 7 shows communications between the bagel distribution system 204 with the hot dozen order system 602 and the dynamic production system 206, the ordering client device 242, and the production client device 236.

As shown, FIG. 7 includes a series of acts 700 performed by or for the dynamic production system 206. For context, the series of acts 700 includes act 516 from FIG. 5 of the dynamic production system 206 generating and providing the updated bagel production plan to the production client device 236. For example, the series of acts 700 is prefaced with one or more acts 502-516 described above.

The series of acts 700 also includes act 702 of the hot dozen order system 602 receiving an order for a customized hot dozen from the ordering client device 242. For example, the hot dozen order system 602 facilitates a user ordering a hot dozen or another quantity of guaranteed oven-fresh hot dozen. In some instances, a hot dozen enables users to select bagel types (e.g., flavors) that are not otherwise available to order.

Act 704 includes the dynamic production system 206 receiving the hot dozen order from the hot dozen order system 602. In response, the hot dozen order system 602 generates an updated bagel production plan to interleave the hot dozen order into the other planned bagel production operations, as shown in act 706. This way, the dynamic production system 206 accounts for and absorbs the hot dozen order while not disturbing other operations.

Act 708 includes the dynamic production system 206 providing the updated bagel production plan with the hot dozen order to the production client device 236. In response, at the designated times, the hot dozen order can be prepared and cooked.

Act 710 includes the bagel distribution system 204, the hot dozen order system 602, and/or the dynamic production system 206 detecting status updates for each stage of the hot dozen order. For example, as the hot dozen order is being made, the dynamic production system 206 detects the start and completion of each production stage.

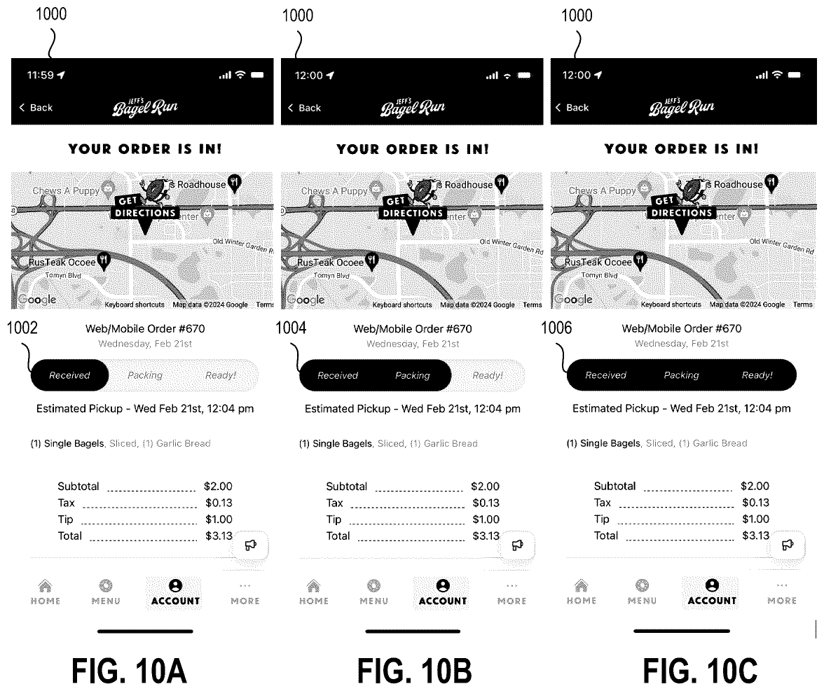

Act 712 includes the hot dozen order system 602 providing status updates for the hot dozen order. For example, the hot dozen order system 602 provides a user interface that includes dynamic and/or interactive status updates regarding one or more stages of the hot dozen order, as shown below in connection with FIGS. 10A-10C.

FIGS. 8A-8H illustrate graphical user interface flows associated with the dynamic production system according to some implementations. The graphical user interfaces may be displayed on a client device 800 that includes a graphical user interface 802 (e.g., a screen that displays user interfaces associated with the dynamic production system 206), which may be a production client device that provides instructions for executing the various bagel production operations included in a bagel preparation plan and/or bagel production plan.

To illustrate, FIGS. 8A-8D correspond to displaying portions of a bagel preparation plan, which includes instructions for preparing specified types and quantities of raw dough. In various implementations, the bagel preparation plan is provided for display on the client device 800 before a target date and at a time (or during a time window) that is in line with the multi-day process timing requirements for making bagels.

As shown, the graphical user interface 802 in FIG. 8A includes a planner interface 810 of the bagel preparation plan that shows the total number 812 of bagel types and their corresponding quantities for the target date. The planner interface 810 also includes a breakdown of bagel types and quantities (in dozens) according to their dough type. To illustrate, the total number 812 in the planner interface 810 shows a total of 84.5 dozen for the target date. In addition, the planner interface 810 shows the breakdown between dough types. For example, the planner interface 810 shows a first quantity 818 of 66.25 dozen to be made from plain or standard dough 814 and the remainder to be made from specialty doughs 816 (e.g., jalapeno, blueberry, and cinnamon raisin doughs).

FIG. 8B shows the planner interface 810 updating to show a breakdown of the bagel types associated with plain or standard dough 814. For example, the client device 800 updates the planner interface 810 upon detecting the selection of the plain or standard dough 814.

As shown in FIG. 8B, the plain or standard dough 814 will be used to make plain bagels 814a, sesame bagels 814b, and other bagel types (e.g., flavors) shown. For each of the bagel types, the planner interface 810 includes an individual count. To illustrate, the plain bagels 814a is planned for a first quantity 818a of 17 dozen and the sesame bagels 818b is planned for a second quantity of 4 dozen.

As shown, the planner interface 810 may allow a user to modify portions of the bagel preparation plan, such as each bagel type quantity. In particular, the planner user interface provides various interface elements and tools for modifying the preparation plan.

In some implementations, the bagel preparation plan builds in overflow stock per bagel type. In some implementations, the bagel preparation plan builds in overflow stock per dough type. In these instances, the overflow stock may be listed as a separate bagel type. In some implementations, the dynamic production system 206 generates an overflow stock range for bagel types and/or dough types. Furthermore, the dynamic production system 206 allows a user to modify the overflow stock number, threshold, or range via user interface elements.

FIGS. 8C-8D include the graphical user interface 802 on the client device 800 displaying a dough prep user interface 820. The dough prep user interface 820 includes instructions for preparing dough batches. For example, the dough prep user interface 820 shows instructions for making multiple dough types, including multiple batches of plain dough and various specialty dough batches.

As shown, the dough prep user interface 820 in FIG. 8C shows plain dough batches 822 while FIG. 8D shows a specialty batch 824. For each batch, the dough prep user interface 820 includes the quantity per batch (e.g., 7 D, 6.5 D, 5.75 D). Batches are shown in dozens but could be per bagel or another measurement type.

The dough prep user interface 820 may also include selectable elements to receive inputs to update the status of each batch. For example, the dough prep user interface 820 shown in

FIG. 8C provides a completion status element 826 and a batch skip element 828 for each batch. As the status of a dough batch changes, the dough prep user interface 820 updates to reflect the change. To illustrate, in FIG. 8D, the completion status element 826 updates to indicate the completion of a dough batch, as shown for many of the plain dough batches. Similarly, the batch skip element 828 updates to indicate Plain Dough Batch 6 was skipped during bagel preparation.

FIGS. 8E-8H correspond to displaying portions of a bagel production plan on the graphical user interface 802 of the client device 800. FIG. 8E shows a bake builder interface 830. As shown, the bake builder interface 830 includes instructions for baking bagel batches, such as a plain bagel batch 832 and an everything bagel batch 834. For example, the bake builder interface 830 shows the types and quantities of bagels included in one of the time intervals (e.g., a 5:13 am cook start time).

In various implementations, the bake builder interface 830 includes selectable elements 838 for manually modifying the bagel production plan. In some instances, the bake builder interface 830 shows the bagel types and quantities determined by the dynamic production system 206 (e.g., the yellow ovals). As described above, the dynamic production system 206 detects the manual and other changes and dynamically updates the bagel production plan to seamlessly absorb, interleave, or incorporate the changes.

When a user selects a bake confirmation element 836, the client device 800 updates the user interface to a bakes in-process interface 840, as shown in FIG. 8F. For example, the bakes in-process interface 840 displays the status 846 of bagels (broken down by bagel type and quantity) at their various cooking stages along with corresponding times. In various implementations, the bakes in-process interface 840 groups bagels by the tray or oven rack they are on. As shown, the bakes in-process interface 840 includes tray information 842 for a baking batch 844. In particular, the tray information 842 shows the number of each bagel per tray. In some instances, a try shows multiple bagel types, and their quantities, on a single try.

FIG. 8G shows the dynamic production system 206 updating the bakes in-process interface 840 to show an update in the status 846 of bagels being baked. The bakes in-process interface 840 may include additional information regarding baking status. In some instances, the bakes in-process interface 840 includes additional or different status indicators.

FIG. 8H shows a bake completion interface 850. The bake completion interface 850 includes status indicator elements 852 and updates them to reflect the completion of a tray (e.g., tray information 842). In some implementations, the bake completion interface 850 includes additional instructions for bagels that need post-baking toppings or for special orders, such as a hot dozen order.

FIG. 8H also shows multiple baking batches in the bake completion interface 850. For example, the bake completion interface 850 shows a second baking batch 854 for batches that have been baked at a later time. In various implementations, the tray information 842 of a batch shows when a tray (which typically holds a dozen bagels) includes multiple types of bagels.

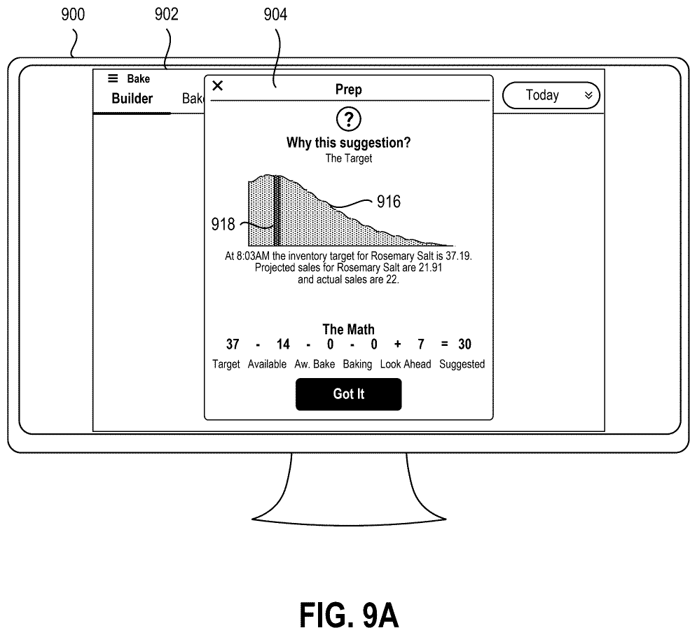

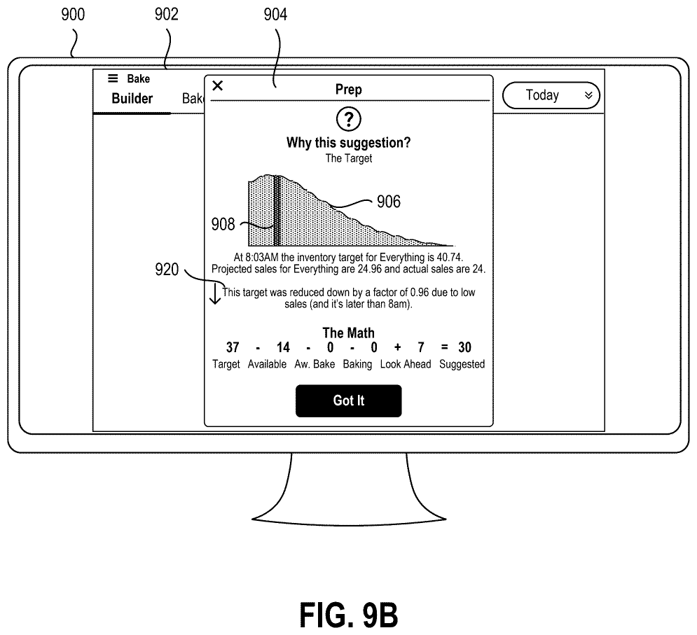

FIGS. 9A-9B illustrate graphical user interface flows associated with adjusting a bagel production plan according to some implementations. As with the previous set of figures, the graphical user interfaces may be displayed on a client device 900 that includes a graphical user interface 902 (e.g., a screen that displays user interfaces associated with the dynamic production system 206), which may be a production client device that provides instructions for executing the various bagel production operations included in a bagel preparation plan and/or bagel production plan.

As shown, FIG. 9A includes a projection tracking interface 904 on the graphical user interface 902 of the client device 900. For example, the projection tracking interface 904 shows how a projected distribution 906 of a first bagel type (e.g., rosemary salt bagels) compares against the actual data for the target date. In particular, FIG. 9A shows that the actual production 908 for rosemary salt bagels is on track with the projected distribution 906 of the bagel production plan.

FIG. 9B shows the projection tracking interface 904 with another projected distribution 916 of a second bagel type (e.g., everything bagels). In this figure, the actual production 918 for everything bagels is not on track with the projected distribution 916 of the bagel production plan. Accordingly, the dynamic production system 206 provides a plan adjustment 920 to the bagel production plan for everything bagels. Indeed, as described above, in various implementations, the dynamic production system 206 updates the bagel production plan when the projection is off by more than a threshold amount (e.g., 20%) and/or uses the comparison to further improve bagel production plans.

FIGS. 10A-10C illustrate graphical user interface flows associated with a user ordering experience according to some implementations. These graphical user interfaces can be displayed on a client device 1000, which may be an ordering client device. For example, the client device 1000 displays the user interfaces in response to a user placing a mobile order or a hot dozen order.

As shown, FIGS. 10A-10C include an order status interface element that updates to indicate the current order status. FIG. 10A shows a first status 1002, indicating that an order has been received. FIG. 10B shows a second status 1004, indicating that an order has been packed. FIG. 10C shows a third status 1006, indicating that an order is ready. The user interface may also include additional or different status updates and user interface elements. For example, the status updates may include different preparation and cooking stages of an order.

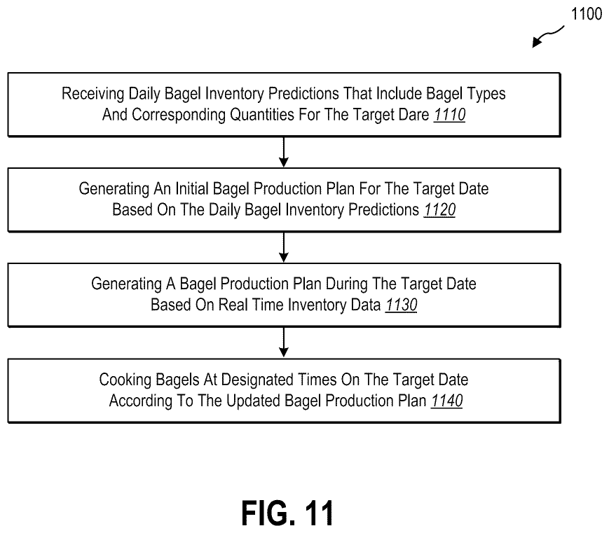

Turning now to FIG. 11, this figure illustrates an example series of acts of a computer-implemented method for managing just-in-time bagel production to ensure oven-fresh, hot bagels according to some implementations. While FIG. 11 illustrates acts according to one or more implementations, alternative implementations may omit, add to, reorder, and/or modify any of the acts shown.

The acts in FIG. 11 can be performed as part of a method (e.g., a computer-implemented method). Alternatively, a computer-readable medium can include instructions that, when executed by a processing system with a processor, cause a computing device to perform the acts in FIG. 11. In some implementations, a system (e.g., a processing system comprising a processor) can perform the acts in FIG. 11. For example, the system includes a processing system and a computer memory including instructions that, when executed by the processing system, cause the system to perform various actions or steps.

As shown, the series of acts 1100 includes act 1110 of receiving daily bagel inventory predictions that include bagel types and corresponding quantities for the target date. For instance, in example implementations, act 1110 involves receiving daily bagel inventory predictions for one or more future dates, including a target date, from an inventory prediction machine learning model that generates the daily bagel inventory predictions from historical inventory data. In some instances, the daily bagel inventory predictions include bagel types and corresponding quantities for the target date.

As further shown, the series of acts 1100 includes act 1120 of generating an initial bagel production plan for the target date based on the daily bagel inventory predictions. For instance, in example implementations, act 1120 involves generating an initial bagel production plan for the target date by a dynamic production system based on the daily bagel inventory predictions, a consumption function, and oven bagel capacity, where the initial bagel production plan includes sets of bagels to be cooked at designated times on the target date.

As further shown, the series of acts 1100 includes act 1130 of generating a bagel production plan during the target date based on real-time inventory data. For instance, in example implementations, act 1130 involves generating one or more updated bagel production plans during the target date based on receiving real-time bagel inventory data.

As shown further, the series of acts 1100 includes act 1140 of cooking bagels at designated times on the target date according to the updated bagel production plan. For instance, in example implementations, act 1140 involves providing an updated bagel production plan for preparing and cooking bagels in one or more ovens at the designated times on the target date according to the updated bagel production plan.

In some implementations, the series of acts 700 includes managing just-in-time bagel production, including receiving daily bagel inventory predictions for one or more future dates including a target date from an inventory prediction machine learning model that generates the daily bagel inventory predictions from historical inventory data, the daily bagel inventory predictions including bagel types and corresponding quantities for the target date; generating an initial bagel production plan for the target date by a dynamic production system based on the daily bagel inventory predictions, a consumption function, and oven bagel capacity, where the initial bagel production plan includes sets of bagels to be cooked at designated times on the target date; generating one or more updated bagel production plans during the target date based on receiving real-time bagel inventory data; and providing an updated bagel production plan for preparing and cooking bagels in one or more ovens at the designated times on the target date according to the updated bagel production plan.

In some implementations, the series of acts 700 includes receiving an order for one or more bagels at a target time on the target date; and updating the bagel types in an updated bagel production plan associated with the target time based on receiving the order for the one or more bagels. In some implementations, the updated bagel production plan minimizes the number of bagels that remain in inventory beyond a freshness time threshold. In some implementations, updating the updated bagel production plan associated with the target time includes removing other bagels previously planned to be cooked for the target time; and moving one or more of the other bagels to a previous or next cooking time interval.

In some implementations, the order is for a dozen different bagel types to be prepared, cooked, and served together at the same time. In some implementations, the series of acts 700 includes providing a client device with status updates of the order, where statuses include order received, order being prepped, bagels being boiled, bagels being baked, bagels receiving toppings, bagels being packed, and bagel order ready. In some implementations, the series of acts 700 includes updating a bagel production plan to prepare fewer or more bagels of a target bagel type than indicated in the daily bagel inventory predictions based on current inventory data of the target bagel type.

In some implementations, the series of acts 700 includes updating a bagel production plan for a target bagel type based on determining an unexpected decrease (or increase or other change) in inventory during a current time interval. In some implementations, the dynamic production system also generates a bagel preparation plan indicating the number of bagels of different bagel types to prepare before the target date; and the different bagel types use standard bagel dough. In some implementations, the bagel preparation plan also indicates an additional number of bagels to be prepared before the target date that has a specialty bagel dough or a non-standard bagel dough.

In some implementations, the series of acts 700 includes managing just-in-time bagel production to ensure fresh, hot bagels, including providing historical sales data to an inventory prediction machine learning model to generate bagel sales predictions for one or more future dates including a target date, the bagel sales predictions including bagel types and corresponding quantities for the target date; generating, by a baking automation system (BAS), based on the bagel sales predictions a bagel preparation plan for the target date that includes a quantity of standard bagel dough; and a bagel production plan for the target date that includes a first set of bagels of one or more bagel types to begin processing at a first time on the target date for oven-fresh distribution, and a second set of bagels of different bagel types to begin processing at a second time on the target date for oven-fresh distribution, where the bagel production plan is generated based on the bagel sales predictions, a consumption function, future orders for bagels on the target date, and oven bagel capacity; and providing the bagel production plan to a client device for preparing and cooking bagels according to the bagel production plan in one or more ovens.

In some implementations, the BAS analyzes the bagel types from the bagel sales predictions for a given day using corresponding consumption functions to generate an initial production plan indicating how much of each bagel type to prepare at each time interval. In some implementations, the series of acts 700 includes providing a current production of bagel types and a current bagel inventory (e.g., current sales and stock) to the BAS at multiple times throughout the target date; and based on incorporating the current production and current bagel inventory, updating the initial production plan into a real-time production plan for a current or future time interval.

In some implementations, the series of acts 700 includes providing updated production data to the BAS that includes the current production of the different bagel types and the current inventory of the bagel types (e.g., current sales); and updating, within the bagel production plan, the second set of bagels to indicate which of the different bagel types to begin processing at the second time on the target date. In some implementations, the bagel preparation plan includes an indication to prepare the quantity of standard bagel dough at least one day before the target date. In some implementations, the bagel preparation plan for the target date includes a quantity of specialty bagel dough or non-standard bagel dough.

In some implementations, the oven bagel capacity includes the number of trays and/or bagels that can be cooked in an oven at a time. In some implementations, a goal of the bagel production plan is that no cooked bagel is unsold before becoming stale. In some implementations, the bagel preparation plan is generated weekly; and the bagel production plan is generated at least once per 10 minutes. In some implementations, the bagel preparation plan generates the bagel sales predictions for a month of future dates.

In some implementations, the series of acts 700 includes providing updated historical data to the inventory prediction machine learning model to generate an updated bagel sale prediction. In some implementations, the series of acts 700 includes fine-tuning the inventory prediction machine learning model based on ground truth sales data correlated to a previous prediction date, where the ground truth sales data includes the actual bagel types and the corresponding quantities for the previous prediction date.

In some implementations, the bagel preparation plan is further based on real-time production operations that include a count of which of the bagel types are currently being prepped, boiled, baked, and/or packed. In some implementations, the bagel preparation plan is further based on a current bagel inventory that includes a count of which of the bagel types are in stock under a freshness time threshold, in stock past the freshness time threshold, and/or recently removed from inventory.

In some implementations, the bagel preparation plan increases production for a first bagel type in a second time interval based on the current bagel inventory moving faster than predicted in a first time interval. In some implementations, the first bagel type is made from the standard bagel dough; and increasing the production for the first bagel type causes a total planned number of other bagel types that use the standard bagel dough to be reduced.

In some implementations, the bagel preparation plan adds a future order for bagels to a time interval corresponding to the future order; and the bagel preparation plan moves other bagels previously planned to be made in the time interval to a previous or next time interval. In some implementations, the BAS determines that less than a full oven capacity is needed for a target time interval; the BAS reduces a cooking time based on an oven baking less than a full oven capacity at the target time interval; and adjusting a start time of one or more future time intervals based on the target time interval being shortened. In some implementations, the BAS identifies a large future order to be ready during one or more fully occupied time intervals; and adding additional time intervals before a first time interval of the target date to accommodate the large future order.

In some implementations, the series of acts 700 includes providing, at each time interval, an updated version of the bagel production plan for display on one or more client devices. In some implementations, the series of acts 700 includes receiving input from a client device regarding a status change for one or more bagels included in the bagel production plan. In some implementations, the series of acts 700 includes receiving an order for a customized hot dozen of bagels to be ready at a third time shortly after the second time; and updating, within the bagel production plan, the second set of bagels to add the customized hot dozen of bagels and advance or delay a dozen of other bagels previously scheduled to cook during the second time.

In some implementations, the series of acts 700 includes providing a user interface that includes a status indicating when each step of the order is being performed. In some implementations, statuses include order received, order being prepped, bagels being boiled, bagels being baked, bagels receiving toppings, bagels being packed, and bagel order ready. In some implementations, the bagels in the order for the customized hot dozen include multiple different bagel types; and each bagel in the order for the customized hot dozen is cooked at the same time in a same oven.

In some implementations, the series of acts 700 includes managing just-in-time bagel production to ensure fresh, hot bagels, including generating bagel sales predictions for a target date using an inventory prediction machine learning model based on historical sales data, the bagel sales predictions including a bagel type and a bagel quantity for the target date, where the target date is a future day when the bagel sales predictions are received; generating, by a baking automation system (BAS), based on the bagel sales predictions: a bagel preparation plan for the target date that includes a quantity of standard bagel dough; and a bagel production plan for the target date that includes: a first number of bagels of the bagel type to begin processing at a first time on the target date for oven-fresh distribution; and a second number of bagels of the bagel type to begin processing at a second time on the target date for oven-fresh distribution, where the bagel production plan is generated based on the bagel sales predictions of the bagel type, a consumption function for the bagel type, future orders for bagels of the bagel type, and the oven's bagel capacity; and providing the bagel production plan for preparing and cooking bagels of the bagel type according to the bagel production plan.

In some implementations, the inventory prediction machine learning model generates the bagel sales predictions for the target date to include two bagel types and corresponding quantities for the two bagel types; and the bagel production plan for the target date includes: a first set of bagels to begin processing at the first time on the target date for oven-fresh distribution, the first set of bagels that includes a first number of bagels for bagels of a first type and a second number of bagels for bagels of a second type; and a second set of bagels to begin processing at the second time on the target date for oven-fresh distribution, the second set of bagels that includes a third number of bagels for the bagels of the first type and a fourth number of bagels for the bagels of the second type. In some implementations, the bagel preparation plan for the target date indicates preparing a standard bagel dough at least one day before the target date to make both the bagels of the first type and bagels of the second type.

In some implementations, the series of acts 700 includes managing just-in-time item production to ensure an optimal quality of items, including providing previous inventory data to an inventory prediction machine learning model to generate item inventory predictions for one or more future dates including a target date, the item inventory predictions including item types and corresponding quantities for the target date; generating, based on the item inventory predictions: an item preparation plan for the target date that includes a quantity of product to prepare before the target date; and an item production plan for the target date that includes: a first set of items of one or more item types to begin processing at a first time on the target date for distribution at the optimal quality; and a second set of items of different item types to begin processing at a second time on the target date for the distribution at the optimal quality, where the item production plan is generated based on the item inventory predictions, an item request model, future requests for items on the target date, and item production capacity; and providing the item production plan for producing items according to the item production plan in one or more production machines. In some implementations, the items include bagels of multiple bagel types.

FIG. 12 illustrates certain components that may be included within a computer system 1200. The computer system 1200 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1200 represents one or more of the client devices, server devices, or other computing devices described above. For example, the computer system 1200 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1200 includes a processing system including a processor 1201. The processor 1201 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1201 may be referred to as a central processing unit (CPU) and may cause computer-implemented instructions to be performed. Although the processor 1201 shown is just a single processor in the computer system 1200 of FIG. 12, in an alternative configuration, a combination of processors (e.g., an ARM and DSP) could be used.

The computer system 1200 also includes memory 1203 in electronic communication with the processor 1201. The memory 1203 may be any electronic component capable of storing electronic information. For example, the memory 1203 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1205 and the data 1207 may be stored in the memory 1203. The instructions 1205 may be executable by the processor 1201 to implement some or all of the functionality disclosed herein. Executing the instructions 1205 may involve the use of the data 1207 that is stored in the memory 1203. Any of the various examples of modules and components described herein may be implemented, partially or wholly, as instructions 1205 stored in memory 1203 and executed by the processor 1201. Any of the various examples of data described herein may be among the data 1207 that is stored in memory 1203 and used during the execution of the instructions 1205 by the processor 1201.

A computer system 1200 may also include one or more communication interface(s) 1209 for communicating with other electronic devices. The one or more communication interface(s) 1209 may be based on wired communication technology, wireless communication technology, or both. Some examples of the one or more communication interface(s) 1209 include a Universal Serial Bus (USB), an Ethernet adapter, a wireless adapter that operates according to an Institute of Electrical and Electronics Engineers (IEEE) 1202.11 wireless communication protocol, a Bluetooth® wireless communication adapter, and an infrared (IR) communication port.

A computer system 1200 may also include one or more input device(s) 1211 and one or more output device(s) 1213. Some examples of the one or more input device(s) 1211 include a keyboard, mouse, microphone, remote control device, button, joystick, trackball, touchpad, and light pen. Some examples of the one or more output device(s) 1213 include a speaker and a printer. A specific type of output device that is typically included in a computer system 1200 is a display device 1215. The display device 1215 used with implementations disclosed herein may utilize any suitable image projection technology, such as liquid crystal display (LCD), light-emitting diode (LED), gas plasma, electroluminescence, or the like. A display controller 1217 may also be provided, for converting data 1207 stored in the memory 1203 into text, graphics, and/or moving images (as appropriate) shown on the display device 1215.

The various components of the computer system 1200 may be coupled together by one or more buses, which may include a power bus, a control signal bus, a status signal bus, a data bus, etc. For clarity, the various buses are illustrated in FIG. 12 as a bus system 1219.

This disclosure describes a subjective data application system within the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry the required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or another data link that enables the transport of electronic data between respective client devices and components (e.g., server devices and/or virtual machines thereon) of the cloud computing system.

Furthermore, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) within a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage, or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions, and therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for managing just-in-time bagel production, comprising:
receiving daily bagel inventory predictions for one or more future dates including a target date from an inventory prediction machine learning model that generates the daily bagel inventory predictions from historical inventory data, the daily bagel inventory predictions including bagel types and corresponding quantities for the target date;
generating an initial bagel production plan for the target date by a dynamic production system based on the daily bagel inventory predictions, a consumption function, and oven bagel capacity, wherein the initial bagel production plan includes sets of bagels to be cooked at designated times on the target date;
generating one or more updated bagel production plans during the target date based on receiving real-time bagel inventory data; and
providing an updated bagel production plan for preparing and cooking bagels in one or more ovens at the designated times on the target date according to the updated bagel production plan.

2. The computer-implemented method of claim 1, further comprising:
receiving an order for one or more bagels at a target time on the target date; and
updating the bagel types in the updated bagel production plan associated with the target time based on receiving the order for the one or more bagels.

3. The computer-implemented method of claim 2, wherein the updated bagel production plan minimizes a number of bagels that remain in inventory beyond a freshness time threshold.

4. The computer-implemented method of claim 3, wherein:
updating the updated bagel production plan associated with the target time includes removing other bagels previously planned to be cooked for the target time; and
moving one or more of the other bagels to a previous or next cooking time interval.

5. The computer-implemented method of claim 3, further comprising providing a client device with status updates of the order, wherein statuses include order received, order being prepped, bagels being boiled, bagels being baked, bagels receiving toppings, bagels being packed, and bagel order ready.

6. The computer-implemented method of claim 1, further comprising updating a bagel production plan to prepare fewer or more bagels of a target bagel type than indicated in the daily bagel inventory predictions based on current inventory data of the target bagel type.

7. The computer-implemented method of claim 1, wherein:
the dynamic production system also generates a bagel preparation plan indicating a number of bagels of different bagel types to prepare before the target date; and
the different bagel types use standard bagel dough.

8. The computer-implemented method of claim 7, wherein the bagel preparation plan also indicates an additional number of bagels to be prepared before the target date that has a specialty bagel dough or non-standard bagel dough.

9. A computer-implemented method for managing just-in-time bagel production, comprising:
providing historical inventory data to an inventory prediction machine learning model to generate bagel inventory predictions for one or more future dates including a target date, the bagel inventory predictions including bagel types and corresponding quantities for the target date;
generating, by a baking automation system (BAS), based on the bagel inventory predictions:
a bagel preparation plan for the target date that includes a quantity of standard bagel dough; and
a bagel production plan for the target date that includes:
a first set of bagels of one or more bagel types to begin processing at a first time on the target date for oven-fresh distribution; and
a second set of bagels of different bagel types to begin processing at a second time on the target date for oven-fresh distribution, wherein the bagel production plan is generated based on the bagel inventory predictions, a consumption function, future orders for bagels on the target date, and oven bagel capacity; and
providing the bagel production plan to a client device for preparing and cooking bagels according to the bagel production plan in one or more ovens.

10. The computer-implemented method of claim 9, wherein the BAS analyzes the bagel types from the bagel inventory predictions for a given day using corresponding consumption functions to generate an initial production plan indicating how much of each bagel type to prepare at each time interval.

11. The computer-implemented method of claim 10, further comprising:
providing a current production of the bagel types and a current bagel inventory to the BAS at multiple times throughout the target date; and
based on incorporating the current production and the current bagel inventory, updating the initial production plan into a real-time production plan for a current or future time interval.

12. The computer-implemented method of claim 9, further comprising:
providing updated production data to the BAS that includes a current production of the bagel types and a current inventory of the bagel types; and
updating, within the bagel production plan, the second set of bagels to indicate which of the different bagel types to begin processing at the second time on the target date.

13. The computer-implemented method of claim 9, wherein the oven bagel capacity includes a number of trays and/or bagels that can be cooked in an oven at a time.

14. The computer-implemented method of claim 9, wherein:
the bagel preparation plan is generated weekly;
the bagel production plan is generated at least once per 10 minutes; and
the bagel preparation plan generates the bagel inventory predictions for a month of future dates.

15. The computer-implemented method of claim 9, wherein:
the bagel preparation plan increases production for a first bagel type;
the first bagel type is made from the standard bagel dough; and
increasing the production for the first bagel type causes a total planned number of other bagel types that use the standard bagel dough to be reduced.

16. The computer-implemented method of claim 9, wherein:
the bagel preparation plan adds a future order for bagels to a time interval corresponding to the future order; and
the bagel preparation plan moves other bagels previously planned to be made in the time interval to a previous or next time interval.

17. The computer-implemented method of claim 9, further comprising providing, at each time interval, an updated version of the bagel production plan for display on one or more client devices.

18. A computer-implemented method for managing just-in-time bagel production, comprising:
generating bagel inventory predictions for a target date using an inventory prediction machine learning model based on historical inventory data, the bagel inventory predictions including a bagel type and a bagel quantity for the target date, wherein the target date is a future day when the bagel inventory predictions are received;
generating based on the bagel inventory predictions:
a bagel preparation plan for the target date that includes a quantity of standard bagel dough; and
a bagel production plan for the target date that includes:
a first number of bagels of the bagel type to begin processing at a first time on the target date for oven-fresh distribution; and
a second number of bagels of the bagel type to begin processing at a second time on the target date for oven-fresh distribution, wherein the bagel production plan is generated based on the bagel inventory predictions of the bagel type, a consumption function for the bagel type, future orders for bagels of the bagel type, and oven capacity for bagels; and
providing the bagel production plan for preparing and cooking bagels of the bagel type according to the bagel production plan.

19. The computer-implemented method of claim 18, wherein:
the inventory prediction machine learning model generates the bagel inventory predictions for the target date to include two bagel types and corresponding quantities for the two bagel types; and
the bagel production plan for the target date includes:
a first set of bagels to begin processing at the first time on the target date for oven-fresh distribution, the first set of bagels that includes a first number of bagels for bagels of a first type and a second number of bagels for bagels of a second type; and
a second set of bagels to begin processing at the second time on the target date for oven-fresh distribution, the second set of bagels that includes a third number of bagels for the bagels of the first type and a fourth number of bagels for the bagels of the second type.

20. The computer-implemented method of claim 19, wherein the bagel preparation plan for the target date indicates preparing a standard bagel dough at least one day before the target date to make both the bagels of the first type and bagels of the second type.
